(19) United States
(12) Patent Application Publication
(10) Pub. No.: US 2026/0341031 A1
(43) Pub. Date: Oct. 29, 2026

(54) SYSTEM FOR NOTIFYING ROAD OCCURRED EVENT BY USING SENSOR DEVICE

(71) Applicant: Byung Joon KIM, Seoul (KR)

(72) Inventor: Byung Joon KIM, Seoul (KR)

(21) Appl. No.: 19/109,060

(22) PCT Filed: Dec. 14, 2023
(86) PCT No.: PCT/KR2023/020661

§ 371 Date: Mar. 5, 2025

(30) Foreign Application Priority Data
Dec. 23, 2022 (KR) 10-2022-0182479
Dec. 12, 2023 (KR) 10-2023-0180060

(51) Int. Cl. G06V 20/54; G06V 10/764; G06V 10/82; G06V 20/20; G08G 1/01; G08G 1/09; G08G 1/0968

(52) U.S. Cl. CPC G06V 20/54; G06V 10/764; G08G 1/0133; G08G 1/0141; G08G 1/093; G08G 1/096855; G06V 10/82; G06V 20/20

(57) ABSTRACT

The present invention relates to a road occurrence event notification system using a sensor device, which comprises an electronic device; and a user terminal; constituting a sensor device infrastructure communicating with each other by a communication protocol, wherein the electronic device constituting the sensor device infrastructure comprises a sensor device for capturing an image of a road; a processor for directly processing an artificial intelligence model based on image processing and determining an occurrence event of the road by using the image of the road captured by the sensor device as an input of the artificial intelligence model based on image processing; and a memory;, and the user terminal comprises a user terminal processor unit for receiving data regarding an occurrence event of a road determined by the above communication protocol; and an output unit for outputting the received data.

### TECHNICAL FIELD

The present invention relates to a system for notifying a road occurred event by using a sensor device.

### BACKGROUND ART

As the number of cars increases, the rate of traffic accidents is increasing significantly. Therefore, it is becoming important to clarify the responsibility for the accident through objective fact-finding related to the accident. Generally, when a traffic accident occurs, the parties agree on whether there is negligence and the percentage of negligence, or the police are dispatched to inspect and record the accident situation and determine the situation at the time of the accident. However, this method has the problem that the method does not accurately analyze the traffic accident situation and relies on the subjective judgment of the parties involved in the accident or the police officer.

To improve these problems, an accident video analysis system and an analysis method using the same that determine the percentage of fault by comparing black box video with similar accident videos are disclosed in Patent Document 1. However, the invention disclosed in Patent Document 1 still has the problem that spatially limited images are used due to black box images, and standard traffic accident information may not be used.

In addition, the video surveillance devices currently installed and in operation are providing traffic information through analysis of real-time road images. However, real-time traffic accident status analysis based on traffic accidents is not being conducted.

Existing driver assistance systems have mainly adopted a method of providing information necessary for driving a vehicle, such as detecting the distance and objects around the vehicle and monitoring the surrounding environment in real time based on sensor technology such as radar and ultrasonic sensors.

However, some sensors must send the collected data to the central server for processing, which may cause delays in data transmission and processing. There were problems such as a large amount of bandwidth being consumed in the process of transmitting large amounts of sensor data to the central server. There were also problems such as privacy issues arising because personal information was transmitted to the central server.

Therefore, a driver assistance system using edge AI is required to solve this problem. Communication between vehicles and communication between vehicles and road infrastructure using edge AI may improve the performance of driver assistance systems by exchanging information about road conditions.

Edge AI may process data locally and make decisions, enabling real-time responses and reducing bandwidth. Edge AI has privacy protection, contributing to improved reliability and stability. The present invention proposes a driver assistance system that works in cooperation with a central server-based system to achieve the best performance.

### DISCLOSURE

### Technical Problem

The present invention provides a system and a method for analyzing a traffic accident, which estimate similarity between actual traffic accident information and standard traffic accident information.

The present invention also provides a system for assisting a driver in real time by using electronic devices and AR devices that constitute a plurality of sensor device infrastructures communicating with each other via a communication protocol.

### Technical Solution

An embodiment of the present invention provides a traffic accident analysis system including: a dataset construction unit for constructing each standard traffic accident data set from a plurality of standard traffic accident information; an omniscient expression unit for mapping image data of actual traffic accident information photographed on a road onto a two-dimensional plane map; and a traffic accident estimation unit for comparing the actual traffic accident information mapped by the omniscient expression unit with each standard traffic accident data set constructed by the dataset construction unit to estimate standard traffic accident information similar to the actual traffic accident information.

In an embodiment, the dataset construction unit may classify the type of traffic accident from each standard traffic accident information and perform labeling according to the type of classified traffic accident to construct each of the above standard traffic accident datasets.

In an embodiment, the types of traffic accidents may include vehicle-to-vehicle, vehicle-to-person, vehicle-to-motorcycle, and vehicle-to-bicycle.

In an embodiment, the dataset constructed in the dataset construction unit may be a dataset constructed including not only image data of standard traffic accident information but also text data which is explanatory material describing the traffic accident.

In an embodiment, the omniscient expression unit may identify the boundary of an object from the actual traffic accident image and display a bounding box to identify the direction and angle of the object.

In an embodiment, the omniscient expression unit may display circular distance lines at predetermined distance intervals on the actual traffic accident image, and perform mapping on the two-dimensional flat map by considering distance and angle using the displayed circular distance lines.

In an embodiment, the actual traffic accident information may include information on traffic signals at the time of the traffic accident video.

In an embodiment, the traffic accident estimation unit may include: a unit for extracting image features in a manner that effectively recognizes and emphasizes features from adjacent images while maintaining spatial information of the image; and a unit for classifying the image.

In an embodiment, the traffic accident analysis system may include a video surveillance device and a management server. The video surveillance device may include the omniscient expression unit and the traffic accident estimation unit. The management server may include the dataset construction unit.

In an embodiment, the traffic accident estimation unit of the video surveillance device may provide the user terminal with standard traffic accident information and similarity information of similar circumstances to actual traffic accident information.

In an embodiment of the present invention, a traffic accident analysis method in a traffic accident analysis system includes a constructing each standard traffic accident data set from a plurality of standard traffic accident information; a mapping image data of actual traffic accident information photographed on a road onto a two-dimensional plane map; and a comparing the actual traffic accident information mapped in the mapping step with each standard traffic accident data set constructed in the constructing step to estimate standard traffic accident information similar to the actual traffic accident information.

In an embodiment of the present invention, a driver assistance system using an AR device includes: an electronic device configuring a plurality of sensor device infrastructures communicating with each other via a communication protocol; and an AR device. The electronic devices constituting the plurality of sensor device infrastructures include a sensor device for capturing an image of a road; a processor for directly processing an image processing-based artificial intelligence model and performing a situation judgment operation regarding the road by using the image of the road captured by the sensor device as an input of the image processing-based artificial intelligence model; and a memory. The AR device includes an AR device processor unit for receiving data regarding the situation judgment by the above communication protocol; and a display unit for outputting the received data.

In an embodiment, the AR device may have a shape wearable by drivers.

In an embodiment, the display unit may output data related to the road conditions as an augmented reality image.

In an embodiment, the road condition may be at least one of a traffic accident on the road, a traffic jam on the road, construction on the road, a breakdown of facilities on the road, a regulation on the road, illegal parking on the road, and a violation of traffic rules on the road.

In an embodiment, the display unit may output data related to the location of a pedestrian or object in the blind spot of a moving vehicle as an augmented reality image.

In an embodiment, the display unit may output data related to road lanes or road surface guide signs as augmented reality images.

In an embodiment, the display unit may output data related to securing a safe distance from other means of transportation located below a critical distance while driving as an augmented reality image.

In an embodiment, the display unit may output data related to the shortest parking space between the driver's destination and the runner's location as an augmented reality image.

In an embodiment of the present invention, a driver assistance system using an AR device includes an electronic device configuring an infrastructure of a plurality of sensor devices communicating with each other via a communication protocol; and an AR device. The electronic devices constituting the above-mentioned plurality of sensor device infrastructure include a sensor device for capturing an image of a road; a processor, and a memory. The AR device includes a display unit; and an AR device processor unit that directly processes an image processing-based artificial intelligence model, receives an image of the road captured by the sensor device through the communication protocol, and performs a situation judgment operation regarding the road using the received image of the road as an input of the image processing-based artificial intelligence model; and a display unit that outputs data regarding the performed situation judgment.

In an embodiment of the present invention, a driver assistance system using an AR device includes an electronic device configuring a plurality of sensor device infrastructures communicating with each other via a communication protocol; an external terminal; and an AR device. The electronic device constituting the plurality of sensor device infrastructure includes a sensor device for capturing an image of a road; a processor, and a memory. The external terminal includes an external terminal processor that processes a general-purpose artificial intelligence model, receives an image of the road captured by the sensor device through the communication protocol, and performs a situation judgment operation regarding the road using the received image of the road as an input of the general-purpose artificial intelligence model. The AR device includes an AR device processor unit that receives data regarding the situation judgment performed by the communication protocol; and a display unit that outputs the received data.

In an embodiment of the present invention, a driver assistance system using an AR device includes an electronic device configuring a plurality of sensor device infrastructures communicating with each other via a communication protocol; an external terminal; and an AR device. The electronic devices constituting the plurality of sensor device infrastructures include: a sensor device for capturing images of a road; a processor for directly processing an image processing-based artificial intelligence model and performing part or all of a situation judgment operation regarding the road by using the images of the road captured by the sensor device as an input of the image processing-based artificial intelligence model; and a memory. The external terminal includes an external terminal processor that processes a general-purpose artificial intelligence model, communicates at least one or more of the image of the road captured by the sensor device and the data regarding situation judgment partially or fully performed by the processor through the communication protocol, and performs a situation judgment operation for partially or fully performed on the road by using at least one or more of the received image of the road and the data regarding situation judgment partially or fully performed by the processor as inputs to the general-purpose artificial intelligence model. The AR device includes: an AR device processor unit that receives data related to some or all of the situation judgments performed from the processor and the external terminal processor; and a display unit that outputs the received data.

In an embodiment of the present invention, a driver assistance system using an AR device includes an electronic device configuring a plurality of sensor device infrastructures communicating with each other via a communication protocol; an external terminal; and an AR device. The electronic devices constituting the plurality of sensor device infrastructure include a sensor device for capturing an image of a road; a processor; and a memory. The external terminal includes an external terminal processor that processes a general-purpose artificial intelligence model, communicates an image of the road captured by the sensor device through the communication protocol, and performs a situation judgment operation on part or all of the road using the received image of the road as an input to the general-purpose artificial intelligence model. The AR device includes an AR device processor unit that directly processes an image processing-based artificial intelligence model, and performs a situation judgment operation on part or all of the road by communicating at least one or more of the image of the road captured by the sensor device and the data regarding situation judgment partially or fully performed by the external terminal processor through the communication protocol, and using the received image of the road and at least one or more of the data regarding situation judgment partially or fully performed by the processor as inputs to the image processing-based artificial intelligence model; and a display unit that outputs the data regarding the performed situation judgment.

In an embodiment of the present invention, a driver assistance system using an AR device includes an electronic device configuring a plurality of sensor device infrastructures communicating with each other via a communication protocol; an external terminal; and an AR device. The electronic devices constituting the above-described plurality of sensor device infrastructures include: a sensor device for capturing images of a road; a processor for directly processing an image processing-based artificial intelligence model and performing a situation judgment operation on part or all of the road using data on the image of the road captured by the sensor device as input to the image processing-based artificial intelligence model; and a memory. The external terminal includes an external terminal processor that processes a general-purpose artificial intelligence model, communicates at least one or more of the image of the road captured by the sensor device and the data regarding situation judgment partially or fully performed by the processor through the communication protocol, and performs a situation judgment operation for partially or fully performed on the road by using at least one or more of the received image of the road and the data regarding situation judgment partially or fully performed by the processor as inputs to the general-purpose artificial intelligence model. The AR device includes an AR device processor unit which directly processes an image processing-based artificial intelligence model, and communicates at least one or more of the image of the road captured by the sensor device, data regarding situation judgment partially or wholly performed by the external terminal processor, and data regarding situation judgment partially or wholly performed by the processor through the communication protocol, and performs a situation judgment operation regarding part or all of the road by using at least one or more of the received image of the road, data regarding situation judgment partially or wholly performed by the external terminal processor, and data regarding situation judgment partially or wholly performed by the processor as inputs of the image processing-based artificial intelligence model; and a display unit which outputs the data regarding the performed situation judgment.

In an embodiment of the present invention, a system for notifying a road occurred event by using a sensor device includes: an electronic device that configures a sensor device infrastructure that communicates with each other according to a communication protocol; and a user terminal, in which the electronic device that configures the sensor device infrastructure includes: a sensor device that captures an image of a road; a processor that directly processes an image processing-based artificial intelligence model and determines an event occurred on the road by using the image of the road, captured by the sensor device, as an input of the image processing-based artificial intelligence model ; and a memory, in which the user terminal includes: a user terminal processor unit that receives data related to the determined the road occurred event according to the communication protocol; and an output unit that outputs the received data.

In an embodiment, the user terminal processor unit may directly process the image processing-based artificial intelligence model, receive the image of the road captured by the sensor device, and determine a portion or all of the road occurred event by using the image of the road as the input of the image processing-based artificial intelligence model.

In an embodiment, the road occurred event may be at least one of a traffic accident on the road, a traffic jam on the road, construction on the road, a breakdown of a facility on the road, a regulation on the road, illegal parking on the road, and an occurrence of a vehicle violating traffic rules on the road.

In an embodiment, the output unit may output an augmented reality image related to the road occurred event.

In an embodiment, the processor may classify the road occurred event based on a classification model learned using actual road occurred events as label data.

In an embodiment of the present invention, a system for notifying a road occurred event by using a sensor device includes: an electronic device that configures a sensor device infrastructure that communicates with each other according to a communication protocol; a user terminal; and an external terminal, in which the electronic devices that configure the sensor device infrastructure includes: a sensor device that captures an image of a road; a processor that directly processes an image processing-based artificial intelligence model and determines the road occurred event by using the image of the road, captured by the sensor device, as an input of the image processing-based artificial intelligence model; and a memory, in which the external terminal includes an external terminal processor that processes a general-purpose artificial intelligence model and receives at least one of an image of the road captured by the sensor device and data regarding the road occurred event determined by the processor, and determines a portion or all of the road occurred event by using at least one of the received image of the road captured by the sensor device and data regarding an the received road occurred event determined by the processor as an input of the general-purpose artificial intelligence model, in which the user terminal includes: a user terminal processor unit that receives at least one of data regarding the road occurred event determined by the processor through the communication protocol and data regarding the road occurred event determined by the external terminal processor; and an output unit that outputs the received data.

### Advantageous Effects

By the above-described configuration, the present invention may objectively determine whether there is negligence and the negligence ratio by analyzing actual traffic accident information and estimating the similarity based on standard traffic accident information.

The present invention also enables analysis of traffic accidents in a two-dimensional plane by mapping image data of actual traffic accident information onto a two-dimensional plane map, thereby enabling more accurate estimation of the type of traffic accident.

The present invention also enables safety diagnosis and prevention of traffic safety solutions by constructing a dataset according to the type of traffic accident as basic data for prevention, diagnosis, response, and prediction of traffic accidents.

The edge AI may process data locally and make decisions, enabling real-time responses, reducing bandwidth, and protecting privacy, thus contributing to improved reliability and stability. The present invention proposes a driver assistance system that works in cooperation with a central server-based system to achieve the best performance.

The present invention has the effect of assisting a driver's driving in real time by having an electronic device and an external terminal that constitute an AR device and a plurality of sensor device infrastructure communicate with each other through a communication protocol, thereby causing the display unit of the AR device to output data on situational judgment related to road conditions in real time.

### DESCRIPTION OF DRAWINGS

FIG. 1a is a block diagram for explaining a driver assistance system using edge AI according to the present invention.

FIG. 1b is a view for explaining a communication network between an external terminal 100, an AR device 20, and an electronic device 10 constituting a plurality of sensor device infrastructures installed on a road according to an embodiment of the present invention.

FIG. 1c is a block diagram for explaining the external terminal 100 according to an embodiment of the present invention.

FIG. 2 is a view for explaining an embodiment in which an AR device 20 receives data from an electronic device 10 that constitutes a plurality of sensor device infrastructures installed on a road according to the present invention.

FIG. 3 is a view for explaining an embodiment in which, when there is a pedestrian located in a blind spot 31 of a vehicle 30 of a driver wearing an AR device according to an embodiment of the present invention, an AR device 20 receives data from the electronic device 10 constituting a plurality of sensor device infrastructures that a pedestrian is located in the blind spot 31.

FIG. 4a is a view for explaining an embodiment in which, when a collision accident occurs between a vehicle 30-5 and 30-6 of a driver wearing an AR device according to an embodiment of the present invention, an external terminal 100 recognizes this and transmits information about the occurrence of a collision accident to the AR device 20 of a vehicle 30-1, 30-2, 30-3, and 30-4 of a driver wearing another AR device.

FIG. 4b is a view showing an augmented reality image projected in the form of a 2D map in the field of vision of a vehicle driver when, in the event of a collision between a vehicle 30-5 and 30-6 of a driver wearing an AR device according to an embodiment of the present invention, the AR device determines that there has been a collision and communicates this to an external terminal 100, and the external terminal 100 recognizes this and transmits information about whether or not a collision has occurred to the AR device 20 of a vehicle 30-1, 30-2, 30-3, and 30-4 of a driver wearing another AR device.

FIG. 4c is a view showing an augmented reality image 21-1 indicating the point of occurrence of a collision projected into the field of vision of a driver of a vehicle when, in the event of a collision between a vehicle 30-5 and 30-6 of a driver wearing an AR device according to an embodiment of the present invention, the AR device determines that a collision has occurred and communicates this to an external terminal 100, and the external terminal 100 recognizes this and transmits information on whether a collision has occurred to the AR device 20 of a vehicle 30-1, 30-2, 30-3, and 30-4 of a driver wearing another AR device.

FIG. 5a is a view for explaining an embodiment of transmitting vehicle usage method information of a vehicle 30 of a driver wearing an AR device to a vehicle driver from an external terminal 100 according to an embodiment of the present invention.

FIG. 5b is a view showing an augmented reality image 21-1 projected into the field of vision of a vehicle driver when information on how to use a vehicle 30 of a driver wearing an AR device is transmitted to the vehicle driver from an external terminal 100 according to an embodiment of the present invention.

FIG. 6 is a view showing an augmented reality image 21-1 that provides distance information from a front vehicle among one embodiment of the augmented reality image 21-1 displayed on a display unit 21 of the AR device 20 according to the present invention.

FIG. 7 is a view showing an augmented reality image 21-1 that highlights a lane on a rainy day, one example of the augmented reality image 21-1 displayed on the display unit 21 of the AR device 20 according to the present invention.

FIG. 8 is a view for explaining an embodiment of guiding a driver to an optimal parking space considering the destination of a vehicle through communication with an external terminal 100 and electronic devices 10-1 and 10-2 constituting a plurality of sensor device infrastructures when a vehicle 30 of a driver wearing an AR device according to the present invention enters a parking lot.

FIG. 9 is a view showing an augmented reality image 21-1 that appears to guide the driver to an optimal parking space considering the destination of the driver through communication with an external terminal 100 and electronic devices 10-1 and 10-2 that constitute a plurality of sensor device infrastructures when the driver's vehicle 30 wearing the AR device according to the present invention enters a parking lot.

FIG. 10 is a view showing an augmented reality image 21-1 that provides a path from a parking space in a building to a destination when a vehicle 30 of a driver wearing an AR device according to the present invention enters a parking lot, and the optimal parking space considering the destination of the driver is guided through communication with an external terminal 100 and electronic devices 10-1 and 10-2 that constitute a plurality of sensor device infrastructures.

FIG. 11 is a schematic view illustrating a traffic accident analysis system according to an embodiment of the present invention.

FIG. 12 is a block diagram illustrating a case where the video surveillance device or management server illustrated in FIG. 11 operates as a general electronic device.

FIG. 13 is a view specifically illustrating a block diagram of a traffic accident analysis system according to another embodiment of the present invention.

FIG. 14 is a view illustrating examples of two-dimensional images by type and/or situation of a standard traffic accident according to an embodiment of the present invention.

FIGS. 15 and 16 are views illustrating examples of matching camera images to a map as depicted according to an embodiment of the present invention.

FIG. 17 is a view illustrating an example of estimating a standard traffic accident type of an actual traffic accident situation according to an embodiment of the present invention.

FIG. 18 is a view illustrating an example of displaying a standard traffic accident estimation result of an actual traffic accident situation according to an embodiment of the present invention.

FIG. 19 is a flow chart representing a traffic accident analysis method according to another embodiment of the present invention.

### MODE FOR INVENTION

Hereinafter, embodiments of the present invention will be described in detail with reference to the attached drawings. In describing the embodiments, descriptions of technical contents that are well known in the technical field to which the present invention belongs and are not directly related to the present invention will be omitted. This is to convey the gist of the present invention more clearly without obscuring it by omitting unnecessary explanations.

For the same reason, some components in the attached drawings are exaggerated, omitted, or schematically illustrated. In addition, the size of each component does not entirely reflect the actual size. The same or corresponding components in each drawing are given the same reference numbers.

The advantages and features of the present invention, and the methods for achieving the same, will become clear with reference to the embodiments described in detail below together with the accompanying drawings. However, the present invention is not limited to the embodiments disclosed below, but may be implemented in various different forms. These embodiments are provided only to make the disclosure of the present invention complete and to fully inform those skilled in the art of the scope of the invention, and the present invention is defined only by the scope of the claims. Like reference numerals refer to like elements throughout the specification.

According to an embodiment of the present invention, a system for notifying a road occurred event by using a sensor device may be provided, and the road occurred event notification system using a sensor device includes an electronic device 10 that constitutes a sensor device infrastructure that communicates with each other through a communication protocol, and

The system may include a user terminal. Here, the user terminal may include an AR device 20 or a user terminal 1140.

According to an embodiment of the present invention, the electronic device 10 constituting a sensor device infrastructure may include a sensor device 13 for capturing an image of a road, a processor 11 for directly processing an image processing-based artificial intelligence model and for determining a road occurred event of a road by using the image of the road captured by the sensor device as an input of an artificial intelligence model based on image processing, and a memory 12. Here, the sensor device 13 may include a camera 1112. Here, the user terminal may include a user terminal processor unit for receiving data regarding a road occurred event determined by the processor 11 by a communication protocol, and an output unit for outputting the received data. The user terminal processor unit may include an AR device processor 23. The output unit may include a display unit 21. Here, the output unit may output an augmented reality image related to a road occurred event. Here, the processor 11 may classify the road occurred event based on a classification model learned using an actual road occurred event as label data.

According to an embodiment of the present invention, the user terminal processor unit directly processes an image processing-based artificial intelligence model, receives an image of the road captured from the sensor device 13, and uses the image as an input of the image processing-based artificial intelligence model to determine some or all of the road occurred events. Here, the road occurred event may be at least one of a road traffic accident, a road congestion, road construction, a road facility failure, a road regulation, illegal parking on the road, and a vehicle violating road traffic rules.

According to another embodiment of the present invention, a system for notifying a road occurred event by using a sensor device may include an electronic device 10, a user terminal, and an external terminal 100 that constitute a sensor device infrastructure that communicate with each other through a communication protocol. The external terminal 100 may include a management server 1120.

According to an embodiment of the present invention, an electronic device 10 constituting a sensor device infrastructure directly processes a sensor device 13 for capturing an image of a road and an image processing-based artificial intelligence model. An electronic device 10 constituting the sensor device infrastructure may include a processor 11 and a memory 12 that determine part or all of a road occurred event by using an image of the road captured by the sensor device 13 as input to an image processing-based artificial intelligence model.

According to an embodiment of the present invention, an external terminal 100 processes a general-purpose artificial intelligence model and receives at least one of an image of a road captured by a sensor device 13 and data regarding a road occurred event determined by a processor 11. The external terminal 100 may include an external terminal processor 110 that uses at least one of the image of a road captured by a sensor device 13 and data regarding a road occurred event determined by a processor 11 as inputs of a general-purpose artificial intelligence model to determine part or all of road occurred events.

According to an embodiment of the present invention, the user terminal may include a user terminal processor unit that receives at least one of data regarding a road occurred event determined by the processor 11 through a communication protocol and data regarding a road occurred event determined by the external terminal processor 110, and an output unit that outputs the received data.

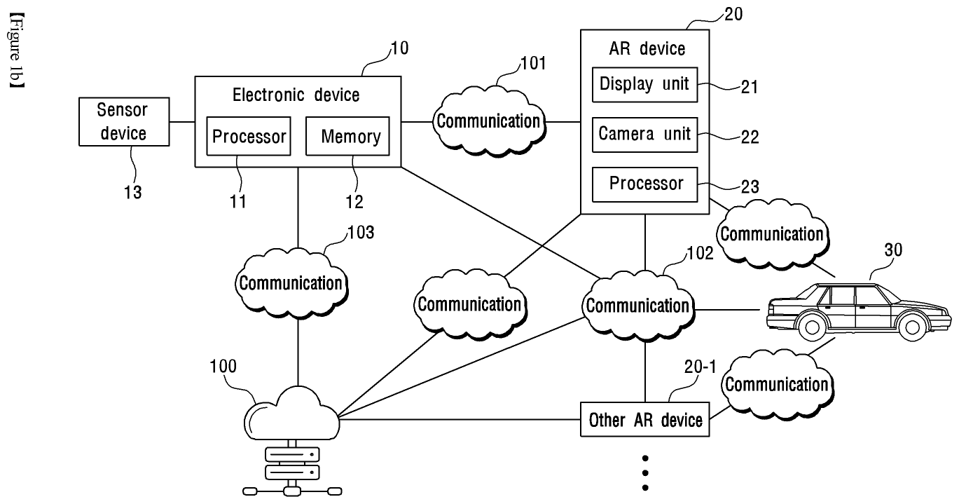

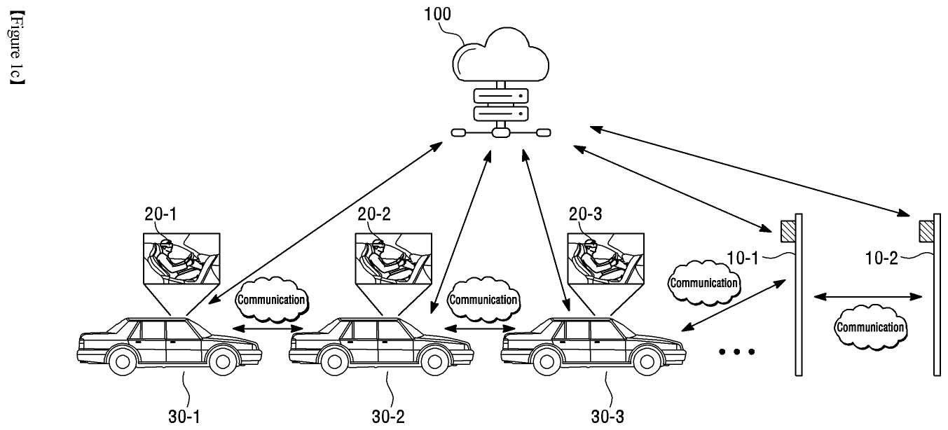

FIG. 1a is a block diagram for explaining a driver assistance system using edge AI according to the present invention.

### Overall Configuration

### Overall Configuration of Electronic Devices 10 That Constitute a Plurality of Sensor Device Infrastructures

As illustrated in FIG. 1a, a driver assistance system using edge AI according to the present invention may include an electronic device 10 that constitutes a plurality of sensor device infrastructures installed on a road, an AR device 20 that provides AR worn by a vehicle driver, and an external terminal 100.

In this specification, the driver assistance system using edge AI is described as an AR device 20 that provides AR worn by a vehicle driver. However, the driver assistance system includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

### Sensor Device 13

According to an embodiment of the present invention, a driver assistance system using edge AI may include an electronic device 10 constituting a plurality of sensor device infrastructures installed on a road. The electronic device 10 constituting a plurality of sensor device infrastructures installed on a road may include a processor 11, a memory 12, and a sensor device 13. Specifically, the sensor device 13 may be a camera, and is a device capable of capturing still images and moving images, and may include one or more image sensors, a lens, an image signal processor (ISP), or a flash (e.g., an LED or a xenon lamp, etc.).

According to an embodiment of the present invention, the sensor device 13 is installed on a smart pole and may capture various traffic images occurring on the road. For example, in an embodiment described below, when a vehicle 30 of a driver wearing an AR device enters a blind spot 31 where the driver's field of vision is blocked and may not see, the sensor device 13 may sense that a pedestrian is located in the blind spot 31. A camera that is one of embodiments of the sensor device 13may capture a pedestrian located in the blind spot 31. As another specific example, in the case where a traffic jam occurs due to an accident or the like on the road along the route from the road where the driver's vehicle 30 is located to the driver's destination while wearing an AR device, which is one of the embodiments described later, the sensor device 13 may sense the point where the accident occurred on the road along the route to the driver's destination. A camera, which is one embodiment of the sensor device 13, may capture the point where the accident occurred.

### Processor 11

According to an embodiment of the present invention, a driver assistance system using edge AI may include an electronic device 10 that constitutes a plurality of sensor device infrastructures installed on a road, and a processor 11. Specifically, the processor 11 may execute a program and control the electronic device 10 that constitutes a plurality of sensor device infrastructures installed on a road. The code of the program executed by the processor 11 may be stored in the memory 12. In addition, the processor 11 may be connected to an external device through an input/output device and exchange data. The external device may be an electronic device that constitutes a plurality of sensor device infrastructures installed on another road, an external terminal 100 such as a server, or an AR device 20 that provides AR worn by a vehicle driver.

According to an embodiment of the present invention, a processor 11 included in an electronic device 10 constituting a plurality of sensor device infrastructures installed on a road may directly process an image processing-based artificial intelligence model, and may also independently process an image processing-based artificial intelligence model. Various models such as an RNN (Recurrent Neural Network), a DNN (Deep Neural Network), and a DRNN (Dynamic Recurrent Neural Network) may be utilized as artificial intelligence network models utilized for such learning. In this way, the processor 11 may process and analyze data in the device itself without sending the data to a central data center or cloud, etc. Therefore, the electronic device 10 that constitutes the plurality of sensor device infrastructures installed on the road may be very useful in situations where high data processing efficiency and real-time response are required.

### Memory 12

According to an embodiment of the present invention, a driver assistance system using edge AI may include an electronic device 10 that constitutes a plurality of sensor device infrastructures installed on a road, and may include a memory 12. Specifically, when a sensor device 13 mounted on an electronic device 10 that constitutes a plurality of sensor device infrastructures installed on a road captures an image of a road, the memory 12 stores the image data. Intermediate results or temporary data generated while the processor 11 processes the data may be stored.

According to an embodiment of the present invention, the memory 12 may be used to record information related to detected events, accidents, and traffic flow, etc., and the processor 11 may use the memory 12 to remember and learn patterns of accidents occurring on the road.

According to an embodiment of the present invention, the memory 12 may be a volatile memory or a nonvolatile memory, and may be referred to as a ‘database’, a ‘storage’, etc.

### AR Device

As illustrated in FIG. 1a, an AR device 20 capable of communicating with an electronic device 10 constituting the above-described plurality of sensor device infrastructures may include a display unit 21, an AR device camera unit 22, and an AR device processor unit 23.

According to an embodiment of the present invention, the AR device 20 may be in a form that a driver may wear on his head, forehead, ears, etc. However, the embodiment of the present invention is not limited thereto.

In this specification, the driver assistance system using edge AI is described as an AR device 20 that provides AR worn by a vehicle driver. However, the system includes not only an AR device 20 that provides AR worn by a vehicle driver, but also all embodiments in which drivers of transportation such as airplanes, helicopters, bicycles, and motorcycles wear AR devices. However, the embodiment of the present invention is not limited thereto.

According to an embodiment of the present invention, an electronic device 10 constituting a plurality of sensor device infrastructures may communicate with an AR device 20 through a communication protocol.

According to an embodiment of the present invention, the AR device 20 may include smart glasses that may be worn by a driver, a head-up display (HUD), an AR safety warning system, a smart helmet, a smart cap, a smart wearable device, an in-vehicle console display with AR function, etc. However, the embodiment of the present invention is not limited thereto.

The attached drawings of this specification describe, assuming one embodiment of the AR devices 20, smart glasses. However, the embodiment of the present invention is not limited thereto. Any device that may communicate with an external device to provide information to a vehicle driver using AR will be included.

According to an embodiment of the present invention, the AR device 20 worn by the driver of the vehicle may have a function of providing augmented reality. This serves to visually convey information to the driver by projecting information necessary during driving. However, the embodiment of the present invention is not limited thereto. Although the accompanying drawing of the present invention has been described as providing augmented reality, it is also possible to provide images of virtual reality in addition to augmented reality to project information necessary during driving and visually convey information to the driver.

According to an embodiment of the present invention, the processor unit 23 of the AR device 20 worn by the vehicle driver may recognize the voice of the vehicle driver. Accordingly, the AR device 20 and the vehicle driver may communicate with each other through voice.

### Display Unit 21

According to the present invention, the display unit 21 of the AR device 20 may project information into the driver's field of vision, and enable the driver to check necessary information while watching the road. Specifically, the display unit 21 may project real-time road maps and navigation information into the driver's field of vision. Information on road conditions, vehicle locations, and surrounding environments may be received by communicating with an electronic device 10 constituting a plurality of sensor device infrastructures based on data collected and processed by the electronic device 10 constituting a plurality of sensor device infrastructures, and provided to the driver's field of vision.

According to an embodiment of the present invention, the display unit 21 may output data related to road conditions as an augmented reality image, but it is also possible to output data as a virtual reality image as well as an augmented reality image.

According to an embodiment of the present invention, data related to road conditions output by the display unit 21 may include road conditions such as traffic accidents on the road, traffic congestion, road construction, road facility failure, road regulations, illegal parking on the road, and violations of road traffic rules.

According to an embodiment of the present invention, the display unit 21 may communicate with the electronic device 10 constituting the plurality of sensor device infrastructures based on data collected and processed by the electronic device 10 constituting the plurality of sensor device infrastructures. The display unit 21 may project real-time traffic information on the road, distance warnings from the vehicle ahead, whether a signal has been violated, traffic signal status, information about nearby stores or tourist attractions, major buildings, etc., and driver status monitoring using the facial recognition technology of the AR device 20 into the driver's field of vision. Accordingly, the driver may detect the current road conditions or the driver's fatigue or drowsiness state, etc. from the display unit 21, and the AR device 20 may not only provide information visually, but also provide information audibly by enabling voice output, etc.

According to an embodiment of the present invention, a processor 11 included in an electronic device 10 constituting a plurality of sensor device infrastructures installed on a road directly processes an image processing-based artificial intelligence model, inputs an image of a road captured by a sensor device 13 into the image processing-based artificial intelligence model, and performs a situation judgment operation regarding the road. Here, the AR device processor unit 23 of the AR device 20 may receive data regarding the situation judgment performed by the processor 11 through a communication protocol, and the display unit 21 of the AR device 20 may output the received data, thereby providing information regarding the road situation to the driver.

As illustrated, the display unit 21 may output data related to securing a safe distance from other means of transportation located below a critical distance while driving as an augmented reality image.

As illustrated, the display unit 21 may output data related to the shortest distance parking space between the driver's destination and the parking location as an augmented reality image.

### AR Device Camera Part 22

According to an embodiment of the present invention, the AR device camera unit 22 of the AR device 20 has a wide field of view and may effectively capture the surrounding environment of the vehicle while the driver is driving. Since the AR device processor unit 23 of the AR device 20 described below includes artificial intelligence based on image processing, the AR device processor unit 23 may process the road conditions captured through the AR device camera unit 22 in the AR device processor unit 23.

According to an embodiment of the present invention, the AR device 20 may receive a manual, such as a method for starting the engine of the corresponding vehicle, from an external terminal 100. Accordingly, the AR device processor unit 23 may identify the face of the vehicle driver through the AR device camera unit 22 and check whether the face matches the face of the vehicle driver registered in advance. In addition, the AR device processor unit 23 may detect the gesture of the vehicle driver through the AR device camera unit 22 and interpret a specific motion as engine start control. In addition, the AR device processor unit 23 may detect the driver's gaze by utilizing the driver's eye tracking technology through the AR device camera unit 22, and may recognize whether the driver is in a state of drowsiness or accumulated fatigue by detecting a specific gaze or a specific pattern.

### AR Device Processor 23

According to an embodiment of the present invention, the AR device 20 may include an AR device processor unit 23, and the AR device processor unit 23 may communicate with an external terminal 100, an electronic device 10 constituting a plurality of sensor device infrastructures, and a driver vehicle 30. The AR device processor unit 23 may directly process an image processing-based artificial intelligence model, and may also independently process an image processing-based artificial intelligence model. Various models such as an RNN (Recurrent Neural Network), a DNN (Deep Neural Network), and a DRNN (Dynamic Recurrent Neural Network) may be utilized as artificial intelligence network models utilized for such learning. In this way, the AR device processor unit 23 may process and analyze data on the device itself without sending the data to a central data center or a cloud. Therefore, the electronic device 10 that constitutes the plurality of sensor device infrastructures installed on the road may be very useful in situations where high data processing efficiency and real-time response are required.

According to an embodiment of the present invention, a processor 11 included in an electronic device 10 constituting a plurality of sensor device infrastructures installed on a road directly processes an image processing-based artificial intelligence model. An image of a road captured by a sensor device 13 is input into an image processing-based artificial intelligence model, so that a situation judgment operation regarding the road may be performed. Here, the AR device processor unit 23 of the AR device 20 may receive data regarding the situation judgment performed by the processor 11 through a communication protocol. The display unit 21 of the AR device 20 may output the received data, thereby providing information regarding the road situation to the driver.

According to another embodiment of the present invention, the AR device processor unit 23 of the AR device 20 may directly process an image processing-based artificial intelligence model. Here, the AR device processor unit 23 may receive an image of the road captured by the sensor device 13 through a communication protocol. The AR device processor unit 23 may input the received image of the road into the image processing-based artificial intelligence model, and perform a situation judgment operation regarding the road. Here, the display unit 21 of the AR device 20 may output data regarding the situation judgment performed by the AR device processor unit 23, and provide information regarding the road situation to the driver.

An embodiment of a specific AR device processor unit 23 will be described below.

### External Terminal 100

FIG. 1c is a block diagram for explaining an external terminal 100 according to an embodiment of the present invention.

As shown in FIG. 1c, the external terminal 100 may include an external terminal processor 110, an external terminal memory 120, and a communication module 170. The external terminal 100 may be an external server or a cloud server. The external server may be a digital device, such as a laptop computer, a notebook computer, a desktop computer, a web pad, or a mobile phone, which has a computing capability equipped with a processor and memory. The external server may be a web server that processes a service. The types of servers described above are merely examples. However, the embodiment of the present invention is not limited thereto.

According to an embodiment of the present invention, an electronic device 10 constituting a plurality of sensor device infrastructures may communicate with an AR device 20 via a communication protocol. In addition, an electronic device 10 constituting a plurality of sensor device infrastructures may communicate with an external terminal 100 via a communication protocol. In addition, an AR device 20 and an external terminal 100 may communicate with each other via a communication protocol. That is, an electronic device 10, an AR device 20, and an external terminal 100 constituting a plurality of sensor device infrastructures may communicate with each other via a communication protocol.

According to an embodiment of the present invention, the external terminal 100 may be a server providing a cloud computing service. More specifically, the external terminal 100 may be a server providing a cloud computing service that processes information with another computer connected to the Internet rather than the user's computer as a type of Internet-based computing. The cloud computing service may be a service that stores data on the Internet and allows the user to use the data or programs required by the user anytime and anywhere through an Internet connection without having to install the data or programs on their computer, and allows the data stored on the Internet to be easily shared and transmitted with simple manipulation and clicks. In addition, the cloud computing service may be a service that not only simply stores data on a server on the Internet, but also performs desired tasks by utilizing the functions of application programs provided on the Web without having to install a separate program, and allows a plurality of people to simultaneously share documents and work on the cloud computing service. In addition, the cloud computing service may be implemented in at least one form among IaaS (Infrastructure as a Service), PaaS (Platform as a Service), Saas (Software as a Service), a virtual machine-based cloud server, and a container-based cloud server. That is, the external terminal 100 of the present invention may be implemented in at least one form among the above-described cloud computing services. The specific description of the cloud computing service described above is only an example, and may include any platform that constructs the cloud computing environment of the present invention.

According to an embodiment of the present invention, the external terminal processor 110 may control the external terminal 100 as a whole, and the external terminal processor 110 may include an AI processor 115. Specifically, the external terminal processor 110 may process general-purpose artificial intelligence. Specifically, the AI processor 115 may learn a neural network using a program stored in the external terminal memory 120. In particular, the AI processor 115 may learn a neural network for recognizing data related to the operations of an electronic device 10 and an AR device 20 constituting a plurality of sensor device infrastructures installed on a road. Here, the neural network may be designed to simulate the human brain structure (e.g., the neuron structure of a human neural network) on a computer. The neural network may include an input layer, an output layer, and at least one hidden layer. Each layer includes at least one neuron having a weight, and the neural network may include synapses connecting neurons. In the neural network, each neuron may output an input signal input through a synapse as a function value of an activation function for the weight and/or bias.

According to an embodiment of the present invention, a plurality of network modes may transmit and receive data according to a connection relationship, respectively, so as to simulate synaptic activity of neurons in which neurons transmit and receive signals through synapses. Here, the neural network may include a deep learning model developed from a neural network model. In the deep learning model, a plurality of network nodes may be located in different layers and may transmit and receive data according to a convolution connection relationship. Examples of the neural network model include various deep learning techniques such as a deep neural network (DNN), a convolutional neural network (CNN), a recurrent neural network, a restricted Boltzmann machine, a deep belief network, and a deep Q-network, and may be applied in fields such as vision recognition, speech recognition, natural language processing, and speech/signal processing.

Meanwhile, the external terminal processor 110 performing the function as described above may be a general-purpose processor (e.g., CPU), but may be an AI-only processor for artificial intelligence learning (e.g., GPU, TPU).

According to an embodiment of the present invention, the external terminal memory 120 may store various programs and data required for the operation of the electronic device 10 and the AR device 20 constituting the infrastructure of a plurality of sensor devices installed on the road. The external terminal memory 120 is accessed by the AI processor 115, and data reading/recording/modifying/deleting/updating, etc. may be performed by the AI processor 115. In addition, the external terminal memory 120 may store a neural network model (e.g., a deep learning model) generated through a learning algorithm for data classification/recognition. Furthermore, the external terminal memory 120 may store not only the learning model 121, but also input data, learning data, learning history, etc.

According to an embodiment of the present invention, the communication module 170 may transmit the AI processing result by the AI processor 115 to an electronic device 10 or AR device 20 that constitutes a plurality of sensor device infrastructures installed on the road.

According to another embodiment of the present invention, the external terminal processor 110 of the external terminal 100 may directly process an image processing-based artificial intelligence model. Here, the external terminal processor 110 may receive an image of the road captured by the sensor device 13 through a communication protocol. The external terminal processor 110 may input the received image of the road into the image processing-based artificial intelligence model, and perform a situation judgment operation regarding the road. Here, the AR device processor unit 23 may receive data regarding the situation judgment performed by the external terminal processor 110 through a communication protocol. The display unit 21 may output the received data regarding the situation judgment, and provide information regarding the road situation to the driver.

### Communication Between Electronic Devices That Configure the Infrastructure of AR Devices, External Terminals, or a Plurality of Sensor Devices Installed on the Road

### Embodiment of Communication Between a Plurality of Devices

FIG. 1b is a view for explaining a communication network between an external terminal 100, an AR device 20, and an electronic device 10 constituting the plurality of sensor device infrastructures installed on a road according to an embodiment of the present invention.

According to an embodiment of the present invention, an electronic device 10 constituting a plurality of sensor device infrastructures may communicate with an AR device 20 via a communication protocol. In addition, an electronic device 10 constituting a plurality of sensor device infrastructures may communicate with an external terminal 100 via a communication protocol. In addition, an AR device 20 and an external terminal 100 may communicate with each other via a communication protocol. That is, an electronic device 10, an AR device 20, and an external terminal 100 constituting a plurality of sensor device infrastructures may communicate with each other via a communication protocol.

As illustrated in FIG. 1b, an external terminal 100 may communicate with a plurality of AR devices 20, and the plurality of AR devices 20 may communicate with electronic devices 10 constituting a plurality of sensor device infrastructures installed on a plurality of roads. The electronic devices 10 constituting a plurality of sensor device infrastructures installed on a plurality of roads may communicate with the external terminal 100. Specifically, the electronic devices 10 constituting a plurality of sensor device infrastructures installed on a plurality of roads may capture and analyze image data generated on the road in real time. The data may be processed and important information may be extracted from the artificial intelligence based on image processing installed in the processor 11 of the electronic devices 10 constituting a plurality of sensor device infrastructures installed on the road. The extracted information may indicate local events, traffic conditions, etc., and such information may be transmitted to the AR device 20 or the external terminal 100 in real time.

According to an embodiment of the present invention, the AR device 20 may receive information about road conditions from an electronic device 10 constituting a plurality of sensor device infrastructures installed on a road and display the information to a vehicle driver. The AR device 20 may locally process some of the information received from the electronic device 10 constituting a plurality of sensor device infrastructures installed on a road, and may also transmit the information to an external terminal 100 as needed.

According to an embodiment of the present invention, an external terminal 100 may centrally process data collected from an AR device 20 or an electronic device 10 constituting a plurality of sensor device infrastructures installed on a road, and perform high-level analysis and judgment. The external terminal 100 may integrate information collected from an AR device 20 or an electronic device 10 constituting a plurality of sensor device infrastructures installed on a road to understand a wider range of road conditions. The external terminal 100 may transmit additional information required to the AR device 20 or an electronic device 10 constituting a plurality of sensor device infrastructures installed on a road. The data collected from the AR device 20 or an electronic device 10 constituting a plurality of sensor device infrastructures installed on a road may be analyzed to generate comprehensive insight into the road conditions. This may be transmitted to the AR device 20 again, and the driver of the vehicle may visually or audibly recognize the data based on judgments about the road conditions, etc.

### Communication Protocol

According to an embodiment of the present invention, an external terminal 100 may communicate with a plurality of AR devices 20. The plurality of AR devices 20 may communicate with electronic devices 10 constituting a plurality of sensor device infrastructures installed on a plurality of roads.

According to an embodiment of the present invention, an electronic device 10 constituting a plurality of sensor device infrastructures may communicate with an AR device 20 via a communication protocol. In addition, an electronic device 10 constituting a plurality of sensor device infrastructures may communicate with an external terminal 100 via a communication protocol. In addition, an AR device 20 and an external terminal 100 may communicate with each other via a communication protocol. That is, an electronic device 10, an AR device 20, and an external terminal 100 constituting a plurality of sensor device infrastructures may communicate with each other via a communication protocol.

In this case, various communication protocols may be used. Here, the selected protocol may vary depending on specific requirements, bandwidth, security level, etc., and the following protocols may be combined and used. For example, lightweight protocols such as MQTT (Message Queuing Telemetry transport) and CoAP (Constrained Application Protocol), which require fewer resources and are optimized for the Internet of Things, may be used. HTTP (HyperTexT Protocol) for fast exchange of hypertext, HTTPS (HyperTexT Protocol Secure) for providing a secure connection and encrypting data, AMQP (Advanced Message Queuing Protocol) for exchanging and communicating messages, and DDS (Data Distribution Service) for exchanging data between real-time systems may be used. In addition, FTP (File Transfer Protocol), RTSP (Real Time Streaming Protocol), RTP (Real-time Transport Protocol), etc. may be used. However, the embodiment of the present invention is not limited thereto.

According to another embodiment of the present invention, an external terminal 100 may communicate with a plurality of AR devices 20. The plurality of AR devices 20 may communicate with electronic devices 10 constituting a plurality of sensor device infrastructures installed on a plurality of roads, and in this case, various communication protocols may be used. Here, a wireless communication technology having an extremely wide bandwidth, such as UWB (Ultra-Wide Band), may be used. A wireless communication protocol based on a method of transmitting data using an extremely wide frequency bandwidth, etc. may be used. This enables accurate search in a wide area of space based on very precise spatial recognition and directionality. However, the embodiment of the present invention is not limited thereto.

According to another embodiment of the present invention, the external terminal processor 110 of the external terminal 100 may process a general-purpose artificial intelligence model. Here, the external terminal processor 110 may receive an image of a road captured by a sensor device 13 through a communication protocol. The external terminal processor 110 may input the received image of the road into a general-purpose artificial intelligence model to perform a situation judgment operation regarding the road. Here, the AR device processor unit 23 may receive data regarding the situation judgment performed by the external terminal processor 110 through a communication protocol. The display unit 21 may output the received data regarding the situation judgment to provide information regarding the road situation to the driver.

According to another embodiment of the present invention, the external terminal processor 110 of the external terminal 100 may process a general-purpose artificial intelligence model. In addition, the AR device processor unit 23 may directly process an image processing-based artificial intelligence model. In addition, the processor 11 may directly process an image processing-based artificial intelligence model. Here, the processor 11 may perform a situation judgment operation on part or all of the road by using the image of the road captured by the sensor device 13 as input to the image processing-based artificial intelligence model. Here, the external terminal processor 110 may receive at least one or more of the situation judgment on part or all of the road performed by the processor 11 and the image of the road captured by the sensor device 13 through a communication protocol. The processor 11 may perform a situation judgment operation on part or all of the road by using at least one or more of the situation judgment on part or all of the road performed by the received processor 11 and the image of the road captured by the sensor device 13 as input to the general-purpose artificial intelligence model. Here, the AR device 20 directly processes the image processing-based artificial intelligence model. The AR device 20 receives at least one of a part or all of the situation judgment regarding the road performed by the processor 11, an image of the road captured by the sensor device 13, and a part or all of the situation judgment performed by the external terminal processor 110. Based on this, the AR device 20 may perform a part or all of the situation judgment operation regarding the road.

According to an embodiment of the present invention, the display unit 21 may output data related to road conditions as an augmented reality image. However, the display unit 21 may also output data as a virtual reality image as well as an augmented reality image.

According to an embodiment of the present invention, data related to road conditions output by the display unit 21 may include road conditions such as traffic accidents on the road, traffic congestion, road construction, road facility failure, road regulations, illegal parking on the road, and violations of road traffic rules.

As illustrated, the display unit 21 may output data related to the location of a pedestrian or object in the blind spot 31 of a moving vehicle as an augmented reality image.

As illustrated, the display unit 21 may output data related to road lanes or road surface guide signs as an augmented reality image.

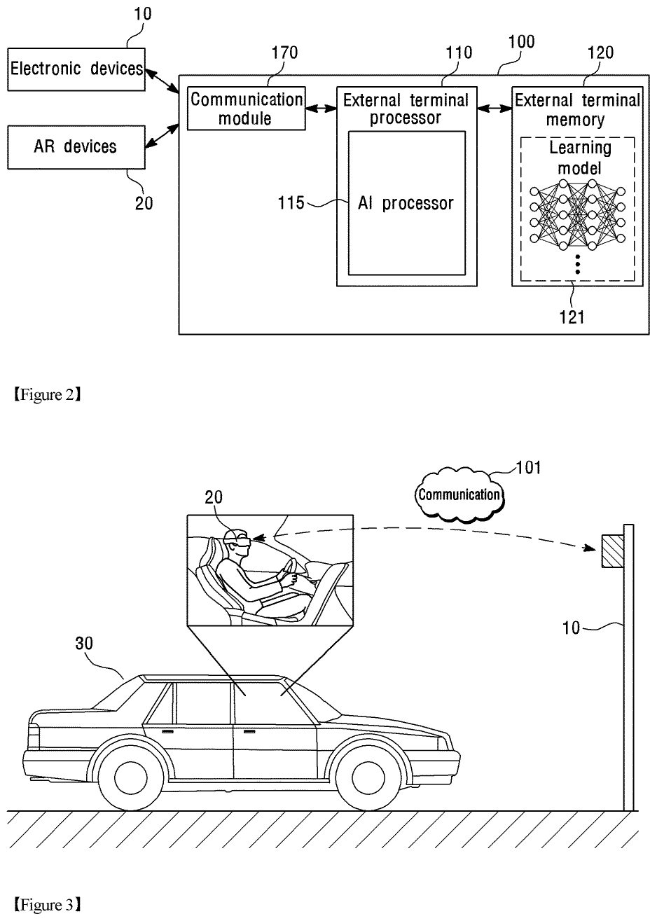

### Embodiment of FIG. 2

FIG. 2 is a view for explaining an embodiment in which an AR device 20 receives data from an electronic device 10 that constitutes a plurality of sensor device infrastructures installed on a road according to the present invention.

In this specification, the driver assistance system using edge AI is described as the AR device 20 that provides AR worn by a vehicle driver. However, the driver assistance system includes not only the AR device 20 that provides AR worn by a vehicle driver, but also all embodiments in which drivers of transportation such as airplanes, helicopters, bicycles, and motorcycles wear AR devices. However, the embodiment of the present invention is not limited thereto.

As described above, according to an embodiment of the present invention, while the driver of the vehicle 30 is driving the vehicle, the driver of the vehicle may wear the AR device 20. As described above, the attached drawing describes an embodiment in which the AR device 20 in the form of ‘smart glasses’ is worn, but the AR device 20 is not limited to the form of ‘smart glasses’.

According to an embodiment of the present invention, an electronic device 10 constituting a plurality of sensor device infrastructures may communicate with an AR device 20 via a communication protocol. In addition, an electronic device 10 constituting a plurality of sensor device infrastructures may communicate with an external terminal 100 via a communication protocol. In addition, an AR device 20 and an external terminal 100 may communicate with each other via a communication protocol. That is, an electronic device 10, an AR device 20, and an external terminal 100 constituting a plurality of sensor device infrastructures may communicate with each other via a communication protocol.

According to another embodiment of the present invention, the external terminal processor 110 of the external terminal 100 may directly process an image processing-based artificial intelligence model. In addition, the processor 11 of the electronic device 10 constituting a plurality of sensor device infrastructures may also directly process an image processing-based artificial intelligence model. The sensor device 13 may capture an image of a road, and the processor 11 may directly process an image processing-based artificial intelligence model to perform part or all of a situation judgment operation regarding the road. Here, the image of the road captured by the sensor device 13 and data regarding the situation judgment regarding the road performed by the processor 11 may be received by the external terminal processor 110 through a communication protocol. The external terminal processor 110 may input the received image of the road and data regarding the situation judgment regarding the road performed by the processor 11 into the image processing-based artificial intelligence model to perform part or all of a situation judgment operation regarding the road. Here, the AR device processor unit 23 may receive data on situation judgment performed by the external terminal processor 110 and data on situation judgment performed by the processor 11 through a communication protocol. The display unit 21 may output the received data on situation judgment to provide information on road conditions to the driver.

According to another embodiment of the present invention, the external terminal processor 110 of the external terminal 100 may process a general-purpose artificial intelligence model. In addition, the AR device processor unit 23 may directly process an image processing-based artificial intelligence model. Here, the external terminal processor 110 and the AR device processor unit 23 may receive an image of a road captured by the sensor device 13 through a communication protocol, and the external terminal processor 110 may input the received image of the road into an image processing-based artificial intelligence model, thereby performing part or all of a situation judgment operation regarding the road. Here, the AR device processor unit 23 may receive data regarding the situation judgment performed by the external terminal processor 110 and the image of the road captured by the sensor device 13 through a communication protocol. The AR device processor unit 23 may input the received data regarding the situation judgment performed by the external terminal processor 110 and the image of the road captured by the sensor device 13 into an image processing-based artificial intelligence model, thereby performing part or all of a situation judgment operation regarding the road. Accordingly, the display unit 21 may output data regarding the situation judgment performed, thereby providing the driver with information regarding the road situation.

According to another embodiment of the present invention, the external terminal processor 110 of the external terminal 100 may process a general-purpose artificial intelligence model. Here, the external terminal processor 110 may receive an image of the road captured by the sensor device 13 through a communication protocol, and the external terminal processor 110 may input the received image of the road into the general-purpose artificial intelligence model to perform a situation judgment operation regarding the road. Here, the AR device processor unit 23 may receive data regarding the situation judgment performed by the external terminal processor 110 through a communication protocol. The display unit 21 may output the received data regarding the situation judgment to provide the driver with information regarding the road situation.

According to another embodiment of the present invention, the external terminal processor 110 of the external terminal 100 may process a general-purpose artificial intelligence model. In addition, the AR device processor unit 23 may directly process an image processing-based artificial intelligence model. In addition, the processor 11 may directly process an image processing-based artificial intelligence model. Here, the processor 11 may perform a situation judgment operation on part or all of the road by using the image of the road captured by the sensor device 13 as input to the image processing-based artificial intelligence model. Here, the external terminal processor 110 may receive at least one or more of the situation judgment on part or all of the road performed by the processor 11 and the image of the road captured by the sensor device 13 through a communication protocol. The processor 11 may perform a situation judgment operation on part or all of the road by using at least one or more of the situation judgment on part or all of the road performed by the received processor 11 and the image of the road captured by the sensor device 13 as input to the general-purpose artificial intelligence model. Here, the AR device 20 directly processes the image processing-based artificial intelligence model. The AR device 20 receives at least one of a part or all of the situation judgment regarding the road performed by the processor 11, an image of the road captured by the sensor device 13, and a part or all of the situation judgment performed by the external terminal processor 110. Based on this, the AR device 20 may perform a part or all of the situation judgment operation regarding the road.

According to another embodiment of the present invention, the external terminal processor 110 of the external terminal 100 may process a general-purpose artificial intelligence model. In addition, the AR device processor unit 23 may directly process an image processing-based artificial intelligence model. Here, the external terminal processor 110 may communicate an image of a road captured by a sensor device 13 through a communication protocol and use this as an input of a general-purpose artificial intelligence model to perform a partial or full situation judgment operation regarding the road. The AR device 20 communicates an image of a road captured by a sensor device 13 and data regarding a partial or full situation judgment regarding the road performed by the external terminal processor 110 through a communication protocol. The AR device 20 may perform a partial or full situation judgment operation regarding the road by using the communicated data as an input of an image processing-based artificial intelligence model.

As described above, the electronic device 10 constituting the plurality of sensor device infrastructures installed on the road may be installed in a form mounted on a smart pole. The electronic device 10 constituting the plurality of sensor device infrastructures installed on the road may capture images of road conditions, etc., process the corresponding data, and in real time, communication 101 between the electronic device and the AR device may be performed with the AR device 20 worn by the driver of the vehicle. Specifically, the communication 101 between the electronic device and the AR device will be performed in a form in which the data processed by the electronic device 10 constituting the plurality of sensor device infrastructures installed on the road is transmitted to the AR device 20 using a communication protocol. However, an embodiment in which the AR device 20 analyzes the state of the vehicle 30 of the driver currently wearing the AR device or the state of the driver of the vehicle, etc., and the electronic device 10 constituting the plurality of sensor device infrastructures installed on the road receives the analyzed data is also possible. In addition, it is also possible to assist the safe driving of the vehicle driver by having the AR device processor 23 of the AR device 20 worn by the vehicle driver analyze the current status of the vehicle 30 of the driver wearing the AR device or the status of the vehicle driver and directly transmit the information to the vehicle driver.

For example, when the AR device processor unit 23 detects that a driver is drowsy while driving, data indicating that drowsy driving has been detected may be transmitted to an electronic device 10 constituting a plurality of sensor device infrastructures installed on a road through communication between the electronic device and the AR device 101. The electronic device 10 constituting a plurality of sensor device infrastructures installed on a road receives the data and transmits the data to another electronic device 10-1 or an external terminal 100 illustrated in FIG. 1b. The electronic device 10 constituting a plurality of sensor device infrastructures installed on a road may transmit information to other vehicles 30-2 and 30-3 of drivers wearing AR devices to be careful of the vehicle 30 of the driver wearing the AR device. In addition, it is also possible for the AR device processor 23 of the AR device 20 worn by the driver of the vehicle to detect drowsy driving of the vehicle 30 of the driver currently wearing the AR device, analyze the detection, and directly transmit information about drowsy driving to the driver of the vehicle, thereby assisting the driver in driving safely. Accordingly, the electronic device 10 constituting the infrastructure of a plurality of sensor devices installed on the road may directly receive the corresponding data from the AR device 20 and transmit information to other vehicles 30-2 and 30-3 of drivers wearing AR devices to be careful of the vehicle 30 of the driver wearing the AR device.

### Embodiment of FIG. 3

FIG. 3 is a view for explaining an embodiment in which, when there is a pedestrian located in the blind spot 31 of a vehicle 30 of a driver wearing an AR device according to an embodiment of the present invention, an AR device 20 receives data from an electronic device 10 constituting a plurality of sensor device infrastructures that a pedestrian is located in the blind spot 31.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

According to an embodiment of the present invention, an electronic device 10 constituting a plurality of sensor device infrastructures may communicate with an AR device 20 via a communication protocol. In addition, an electronic device 10 constituting a plurality of sensor device infrastructures may communicate with an external terminal 100 via a communication protocol. In addition, an AR device 20 and an external terminal 100 may communicate with each other via a communication protocol. That is, an electronic device 10, an AR device 20, and an external terminal 100 constituting a plurality of sensor device infrastructures may communicate with each other via a communication protocol.

As illustrated, the display unit 21 may output data related to the location of a pedestrian or object in the blind spot 31 of a moving vehicle as an augmented reality image.

As illustrated, a vehicle 30 of a driver wearing an AR device may have a blind spot 31. A blind spot 31 of a vehicle may refer to an area in which it is difficult for the driver to directly check the view from inside the vehicle, and may mainly correspond to the side, rear, and rear sides of the vehicle. When an object or pedestrian in the blind spot 31 suddenly appears while the driver is driving, the object or pedestrian may affect traffic safety, so a system that detects and warns the driver of the blind spot 31 may be required.

As described above, the electronic device 10 constituting the plurality of sensor device infrastructures installed on the road may be installed in a form mounted on a smart pole. The electronic device 10 constituting the plurality of sensor device infrastructures installed on the road may capture a pedestrian or an object in the blind spot 31 of the driver while driving and process the corresponding data. Accordingly, communication 101 between the electronic device and the AR device may be performed in real time with the AR device 20 worn by the driver of the vehicle. For a specific example, the communication 101 between the electronic device and the AR device may mainly use a communication protocol to transmit data processed by the electronic device 10 constituting the plurality of sensor device infrastructures installed on the road to the AR device 20. The AR device 20 may display a warning sign through the display unit 21 to indicate that a pedestrian is currently located in the blind spot 31, and may transmit a guidance voice.

According to another embodiment of the present invention, the AR device processor unit 23 of the AR device 20 worn by the driver of the vehicle may detect in real time that a pedestrian is located in the blind spot 31 and recognize this. In this case, the AR device 20 may display a warning sign through the display unit 21 to indicate that a pedestrian is currently located in the blind spot 31, and may transmit a guidance voice. In addition, when the AR device 20 of a moving vehicle detects that a pedestrian is located in the blind spot 31, the AR device 20 of other vehicles located at a distance less than a threshold distance from the blind spot 31 may display a warning sign to indicate that a pedestrian is currently located in the blind spot 31, and may transmit a guidance voice. In addition, when the AR device 20 of a moving vehicle detects that a pedestrian is located in a blind spot 31, it is also possible to communicate with an electronic device 10 or an external terminal 100 that constitutes a plurality of sensor device infrastructures installed on the road so that the AR devices 20 of other vehicles located at a distance less than a critical distance from the blind spot 31 receive the corresponding data.

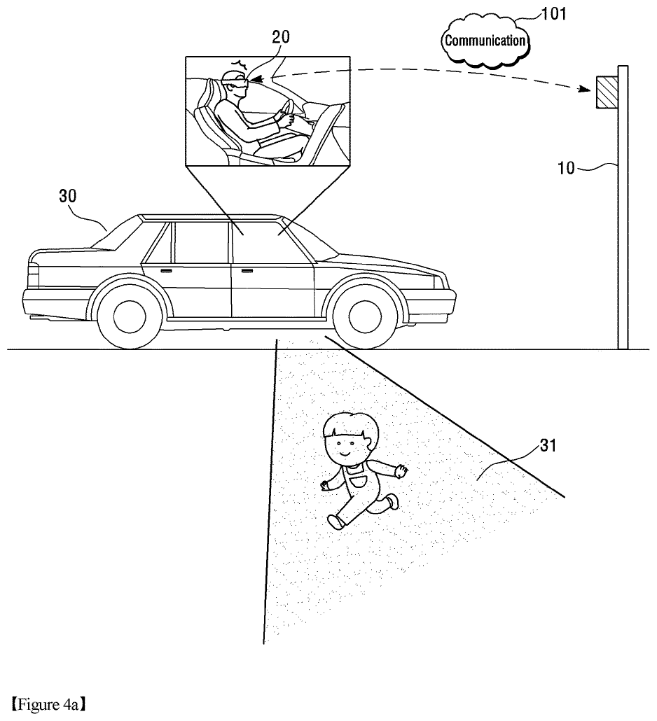

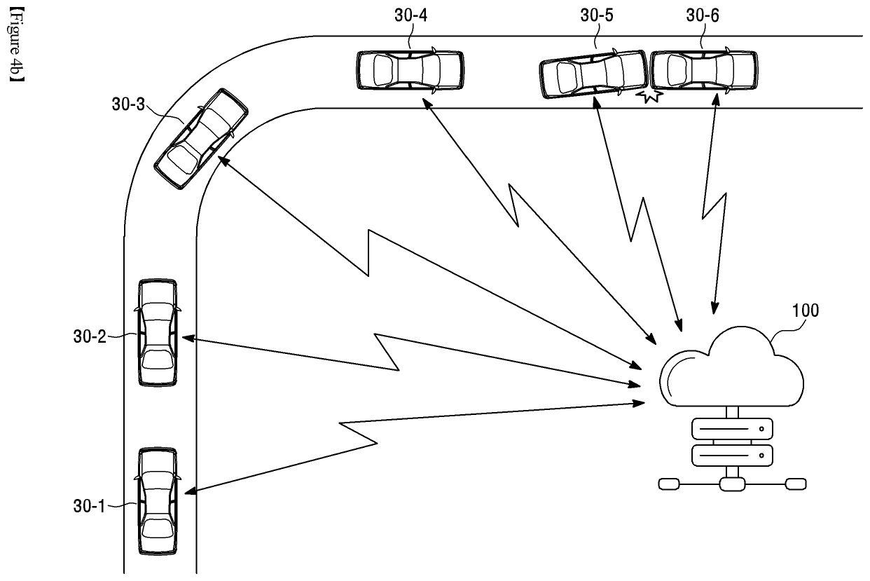

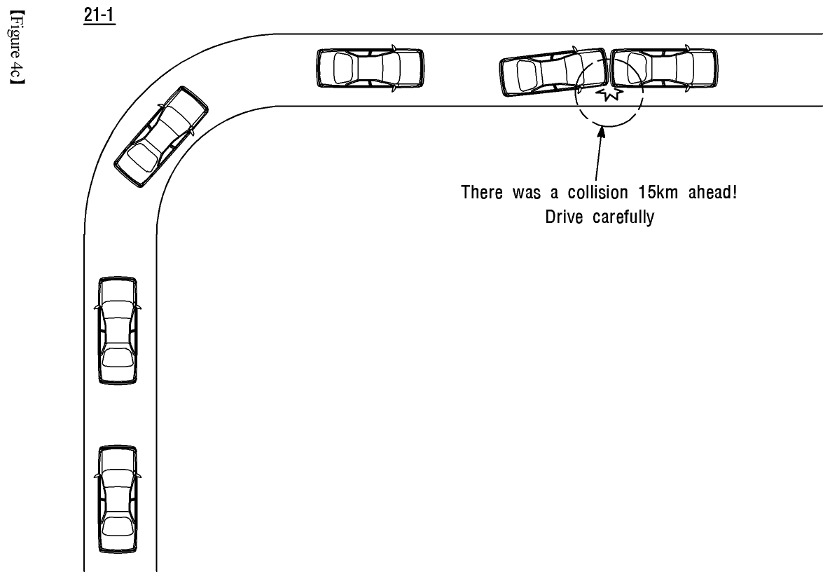

### Embodiment of FIG. 4

FIG. 4a is a view for explaining an embodiment in which, when a collision accident occurs between a vehicle 30-5 and 30-6 of a driver wearing an AR device according to an embodiment of the present invention, an external terminal 100 recognizes this and transmits information about the occurrence of a collision accident to an AR device 20 of a vehicle 30-1, 30-2, 30-3, and 30-4 of a driver wearing another AR device. FIG. 4b is a view showing an augmented reality image projected in the form of a 2D map in the field of vision of a vehicle driver when, in the event of a collision between a vehicle 30-5 and 30-6 of a driver wearing an AR device according to an embodiment of the present invention, the AR device determines that there has been a collision and communicates this to an external terminal 100, and the external terminal 100 recognizes this and transmits information about whether or not a collision has occurred to the AR device 20 of a vehicle 30-1, 30-2, 30-3, and 30-4 of a driver wearing another AR device.

FIG. 4c is a view showing an augmented reality image 21-1 indicating the point of occurrence of a contact accident projected into the field of vision of a driver of a vehicle when, in the event of a contact accident between a vehicle 30-5 and 30-6 of a driver wearing an AR device according to an embodiment of the present invention, the AR device determines that there has been a contact accident and communicates this to an external terminal 100, and the external terminal 100 recognizes this and transmits information on whether or not a contact accident has occurred to an AR device 20 of a vehicle 30-1, 30-2, 30-3, and 30-4 of a driver wearing another AR device.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

According to the present invention, a driver wearing an AR device may verbally command the AR device 20, and the AR device processor unit 23 may recognize the voice of the driver wearing the AR device and perform a task according to the command. For example, if a command is given to “search for a route to the destination,” the AR device processor unit 23 may recognize the voice of the driver wearing the AR device and perform a task according to the command, and may project the route to the destination onto the driver's field of vision through the display unit 21. For another example, when a driver gives a command to “find the nearest cafe on the route to the destination,” the AR device processor unit 23 may recognize the voice of the driver wearing the AR device and perform a task according to the command.

As illustrated, a case is explained by assuming that a collision accident occurs between a vehicle 30-5 and 30-6 of a driver wearing an AR device, or a road condition becomes congested. In the attached drawing, a collision accident between a vehicle 30-5, 30-6 of a driver wearing an AR device is depicted. However, the embodiment of the present invention is not limited to the collision accident. The collision accident may include all road events including accidents and congestion. In addition, although not shown in the attached drawing, all or some drivers of vehicles 30-1, 30-2, 30-3, and 30-4 of drivers wearing other AR devices and vehicles 30-5 and 30-6 of drivers wearing AR devices are wearing the AR device 20 of the present invention.

As described above, in the event of a collision accident between a vehicle 30-5 and 30-6 of a driver wearing an AR device, the AR device 20 worn by the driver of the vehicle 30-5 and 30-6 of the driver wearing the AR device may capture the current collision accident, process the data with the AR device processor 23, and transmit/receive the corresponding data to/from an external terminal 100. The external terminal 100 may receive the corresponding data and recognize that the vehicle 30-5 and 30-6 of the driver wearing the AR device has been involved in a collision accident through the AI processor 115 of the external terminal processor 110. The external terminal 100 may transmit the collision accident occurrence data to the AR device 20 worn by the driver of the vehicle 30-1, 30-2, 30-3, and 30-4 of the driver wearing another AR device through the communication module 170.

According to an embodiment of the present invention, the AR device 20 worn by the driver of the vehicle 30-1, 30-2, 30-3, and 30-4 of the driver wearing another AR device may visually display through the display unit 21 that a collision accident has occurred near the road on which the vehicle is currently being driven. The AR device 20 may provide information on how much time delay there will be in reaching the destination because a collision accident has occurred near the road on which the vehicle is currently being driven.

As shown in FIG. 4b, a driver wearing an AR device 20 may view an augmented reality image 21-1 through the display unit 21 and visually confirm that a collision accident has occurred in front. According to an embodiment of the present invention, guidance such as taking a detour by another route may be provided on the display unit 21. Since the AR device 20 may provide a function of guiding the route in real time, a wearer of the AR device 20 may prepare in advance for a collision accident in front by using an alternative road or driving safely through the augmented reality image 21-1.

As shown in FIG. 4c, a driver wearing an AR device 20 may view an augmented reality image 21-1 through the display unit 21 and may also visually check in detail the point where a frontal collision occurred.

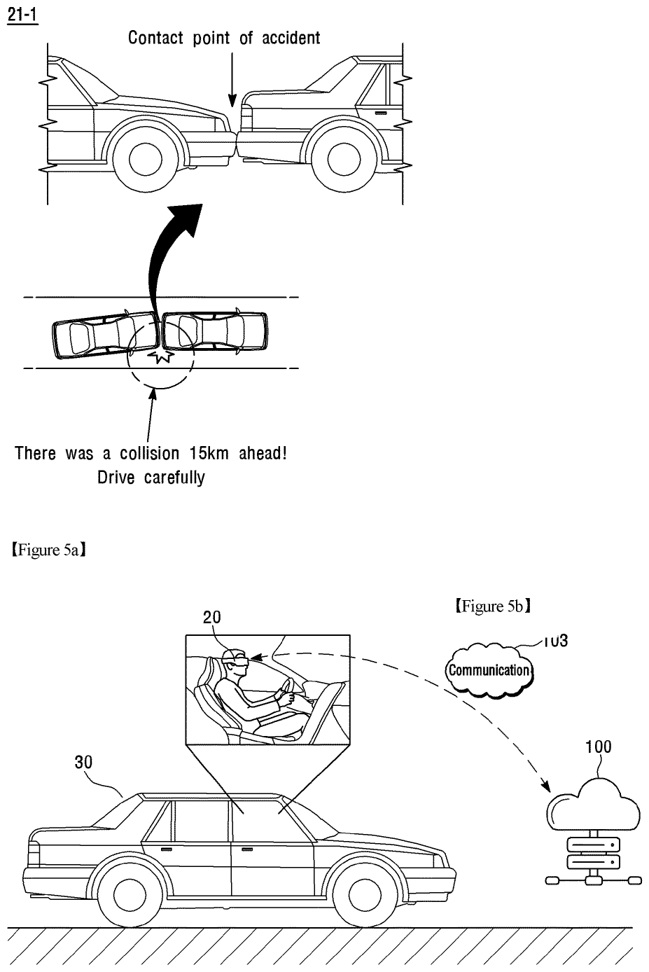

### Embodiment of FIG. 5

FIG. 5a is a view for explaining an embodiment of transmitting vehicle usage method information of a vehicle 30 of a driver wearing an AR device 20 to a vehicle driver from an external terminal 100 according to an embodiment of the present invention.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

FIG. 5b is a view showing an augmented reality image 21-1 projected into the field of vision of a vehicle driver when information on how to use a vehicle 30 of a driver wearing an AR device is transmitted to the vehicle driver from an external terminal 100 according to an embodiment of the present invention.

According to an embodiment of the present invention, a vehicle driver may wear an AR device 20, and the AR device 20 may communicate data with an external terminal 100. Accordingly, the AR device 20 may receive a vehicle operation method for a specific vehicle of the vehicle driver from the external terminal 100 and sequentially display the method on the display unit 21 of the AR device 20, thereby allowing the vehicle driver to acquire a driving method for the corresponding vehicle.

According to another embodiment of the present invention, a vehicle driver may wear an AR device 20, and the AR device processor unit 23 may detect and recognize the vehicle. Accordingly, the present invention may sequentially display a vehicle operation method for a specific vehicle of the vehicle driver on the display unit 21 of the AR device 20, thereby allowing the vehicle driver to acquire a driving method for the vehicle.

According to a specific embodiment, as shown in FIG. 5b, when a driver of a vehicle gets into a vehicle 30 of a driver wearing an AR device, an augmented reality image 21-1 may be projected into the field of vision of the driver of the vehicle when the driver wears the AR device 20. If the driver of the vehicle is inexperienced in driving the vehicle, the driver may be guided on how to operate the vehicle through the projected augmented reality image 21-1. For a specific example, the words “First of all, please fasten your seat belt” may appear with an arrow toward the seat belt through the augmented reality image 21-1, and a guidance voice may be output from the AR device 20 at the same time. As a result, the driver of the vehicle may recognize that he or she must fasten his or her seat belt first.

Then, when the driver of the vehicle fastens his or her seat belt, the AR device processor unit 23 may recognize that the driver of the vehicle has fastened his or her seat belt, and the display unit 21 may guide the next step of operation. In this case, the augmented reality image 21-1 may provide a phrase such as “Next, please adjust the side mirrors”, and when the driver of the vehicle adjusts the side mirrors appropriately, the AR device processor unit 23 may recognize that the driver of the vehicle has adjusted the side mirrors appropriately. Thereafter, the augmented reality image 21-1 may provide a phrase such as “Next, please release the parking brake”, and at this time, the augmented reality image 21-1 may display the parking brake portion using an effect such as an arrow or highlight so that the driver of the vehicle may recognize where the parking brake is located. Here, when the driver of the vehicle releases the parking brake, the AR device processor unit 23 may recognize that the driver of the vehicle has released the parking brake. Thereafter, the augmented reality image 21-1 may provide a phrase such as “Next, please turn on the engine,” and at this time, as shown in FIG. 5b, the augmented reality image 21-1 may display the engine part using an effect such as an arrow or highlight so that the driver of the vehicle may recognize where the part to turn on the engine is located.

However, the embodiment of the present invention is not limited thereto. The operation method of the vehicle may differ depending on the type of vehicle. In addition, since the operation method of the vehicle may differ depending on the model of the vehicle, the AR device 20 may receive information reflecting the type of vehicle, the model of the vehicle, the degree of the driver's inexperience in driving, etc. from the external terminal 100 and provide an augmented reality image 21-1 accordingly. In addition, the AR device 20 does not receive information reflecting the type of vehicle, the model of the vehicle, the degree of the driver's inexperience in driving, etc. from the external terminal 100. The AR device processor unit 23 may detect and recognize the model of the vehicle, etc. by itself and provide an augmented reality image 21-1 accordingly.

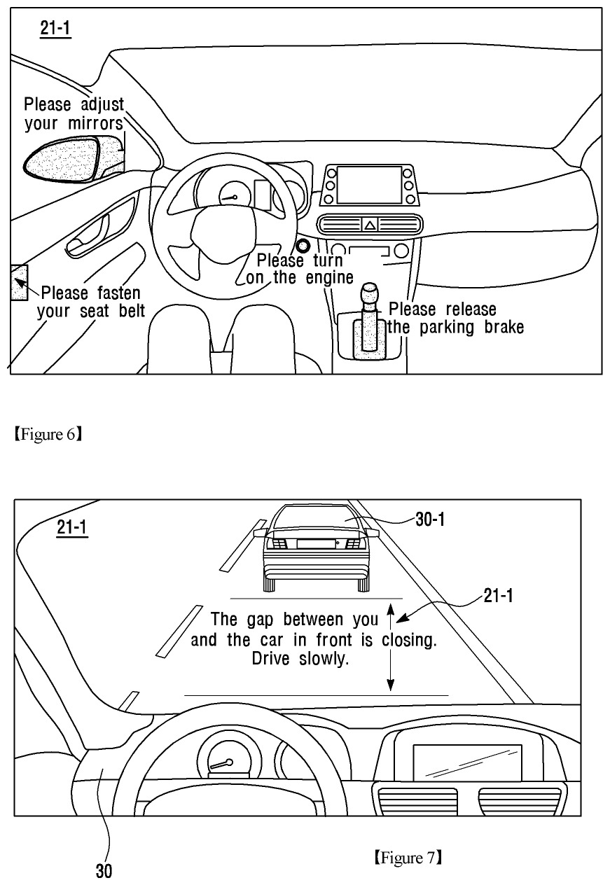

### Embodiment of FIG. 6

FIG. 6 is a view showing an augmented reality image 21-1 that provides distance information from a front vehicle among one embodiment of an augmented reality image 21-1 displayed on a display unit 21 of an AR device 20 according to the present invention.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

As illustrated, the display unit 21 may output data related to securing a safe distance from other means of transportation located below a critical distance while driving as an augmented reality image.

According to an embodiment of the present invention, when a vehicle 30 of a driver wearing an AR device gets closer to another vehicle or a vehicle 30-1 of a driver wearing another AR device by a certain distance or less while driving, an image indicating the distance from the vehicle in front with an arrow may be provided along with a phrase and a guidance voice such as “The distance from the vehicle in front is getting narrower. Slow down” through an augmented reality image 21-1 displayed on the display unit 21 of the AR device 20. According to another embodiment, when the distance from the vehicle in front gets closer to a certain distance or less, an augmented reality image 21-1 displayed on the display unit 21 of the AR device 20 may simultaneously output a phrase such as “The distance from the vehicle in front is getting narrower. Slow down” along with a guidance voice of the AR device 20, thereby guiding the driver of the vehicle to recognize the distance from the vehicle in front and exercise caution. In this case, the AR device 20 may recognize that it is getting closer to a certain distance or less while driving through communication with an electronic device 10 or an external terminal 100 that constitutes a plurality of sensor device infrastructures. However, it is also possible for the AR device processor unit 23 to determine that it is getting closer to a certain distance or less while driving and to simultaneously output a guidance voice of the AR device 20 along with a phrase such as “The gap to the car in front is narrow. Slow down” through an augmented reality image 21-1 displayed on the display unit 21 of the AR device 20, thereby guiding the driver of the vehicle to recognize the gap to the car in front and be careful.

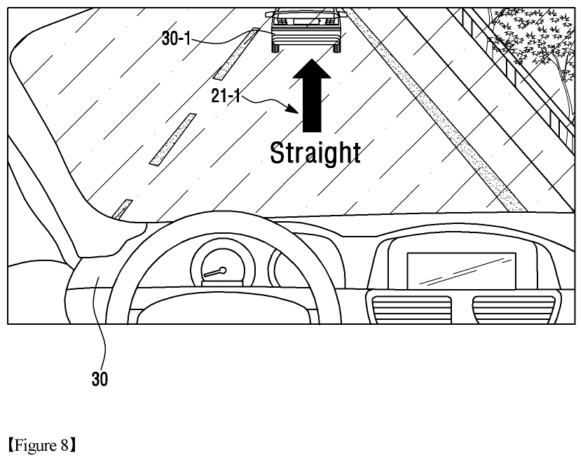

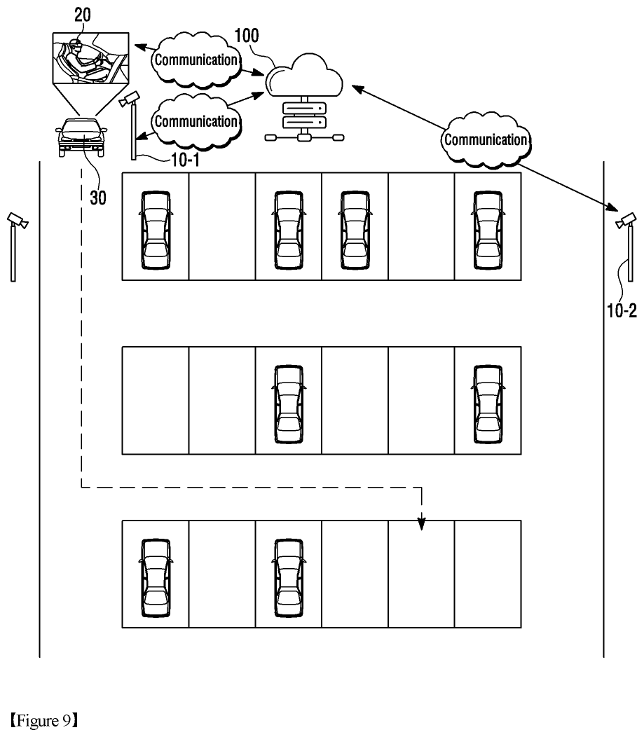

### Embodiment of FIG. 7

FIG. 7 is a view showing an augmented reality image 21-1 that highlights a lane on a rainy day, one example of an augmented reality image 21-1 displayed on a display unit 21 of an AR device 20 according to the present invention.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

As illustrated, the display unit 21 may output data related to road lanes or road surface guide signs as an augmented reality image.

According to an embodiment of the present invention, when the weather is bad, such as when it rains or snows, while the vehicle 30 of the driver wearing the AR device is driving, the driver's field of vision may be obstructed, and the lane may appear blurry. In this case, the lane may be highlighted or the image of the lane may be provided clearly above the lane through the augmented reality image 21-1 displayed on the display unit 21 of the AR device 20. According to another embodiment, when the weather is bad, such as when it rains or snows, while the vehicle 30 of the driver wearing the AR device is driving, the guidance text on the road may be highlighted or the image of the guidance text may be provided clearly through the augmented reality image 21-1 displayed on the display unit 21 of the AR device 20. In this case, the AR device 20 may recognize that the weather is bad, such as when it rains or snows, through communication with the electronic device 10 or the external terminal 100 that constitutes a plurality of sensor device infrastructures. However, it is also possible for the AR device processor unit 23 to determine that the weather is bad, such as rain or snow, and to highlight or clearly provide an image of the guidance text on the road through the augmented reality image 21-1 displayed on the display unit 21 of the AR device 20.

### Embodiments of FIGS. 8, 9 and 10

FIG. 8 is a view for explaining an embodiment of guiding a driver to an optimal parking space considering the destination of a vehicle through communication with an external terminal 100 and electronic devices 10-1 and 10-2 constituting a plurality of sensor device infrastructures when a vehicle 30 of a driver wearing an AR device according to the present invention enters a parking lot.

In this specification, the driver assistance system using edge AI is described as an AR device 20 that provides AR worn by a vehicle driver. However, the present invention includes not only an AR device 20 that provides AR worn by a vehicle driver, but also embodiments in which drivers of transportation such as airplanes, helicopters, bicycles, and motorcycles wear AR devices. However, the embodiment of the present invention is not limited thereto.

FIG. 9 is a view showing an augmented reality image 21-1 that appears to guide the driver to an optimal parking space considering the destination of the driver through communication with an external terminal 100 and electronic devices 10-1 and 10-2 that constitute a plurality of sensor device infrastructures when the driver's vehicle 30 wearing the AR device according to the present invention enters a parking lot.

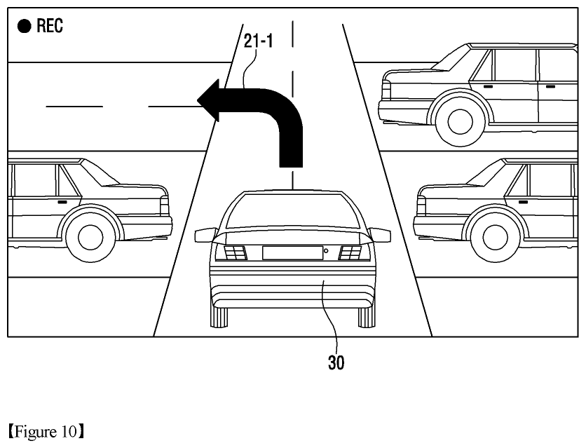

FIG. 10 is a view showing an augmented reality image 21-1 that provides a path from a parking space in a building to a destination when a vehicle 30 of a driver wearing an AR device according to the present invention enters a parking lot, and the optimal parking space considering the destination of the driver is guided through communication with an external terminal 100 and electronic devices 10-1 and 10-2 constituting a plurality of sensor device infrastructures.

As illustrated, the display unit 21 may output data related to the shortest distance parking space between the driver's destination and the parking location as an augmented reality image.

As described above, according to an embodiment of the present invention, when a driver of a vehicle has a destination 40 within a building such as a complex shopping center such as a department store or outlet, the distance to the destination 40 within the building of the driver of the vehicle may be relatively short depending on the parking location. Accordingly, as illustrated in FIG. 8, an external terminal 100 communicates with an AR device 20 or an electronic device 10 constituting a plurality of sensor device infrastructures for a building such as a complex shopping center, so that the AR device 20 may guide the optimal parking location by considering the current parking situation and the optimal route to the destination 40 within the building for a specific vehicle driver.

As illustrated in FIG. 9, the driver of the vehicle may be guided to the optimal parking location determined by the AR device 20 in consideration of the current parking situation and the optimal path to the destination 40 within the building of the specific driver of the vehicle through the augmented reality image 21-1. Specifically, the driver may be visually guided to the optimal parking location in real time through an arrow on the augmented reality image 21-1 indicating the vehicle 30 of the driver currently wearing the AR device. As illustrated in FIG. 10, for example, there is a case where the destination 40 within the building of the specific driver of the vehicle is a movie theater within the building. In this case, if the driver parks in the current parking space provided by the AR device 20 through the augmented reality image 21-1, the driver of the vehicle may go to the destination 40 within the building of the specific driver of the vehicle through a certain path, and the driver of the vehicle may recognize that the parking space is the shortest distance to the destination 40 within the building of the specific driver of the vehicle. Accordingly, the augmented reality image 21-1 may provide a route to a destination 40 within a building for a specific vehicle driver, and may simultaneously provide a phrase and a guidance voice such as “If you want to go to the movie theater, this is the closest place to park!!”

According to another embodiment of the present invention, if there is no optimal parking space, the AR device processor unit 23 may recommend a parking space with the shortest distance to the destination 40 within the building of a specific vehicle driver among the remaining parking spaces to the vehicle driver. The vehicle driver may recognize that the parking space is the shortest distance to the destination 40 within the building of the specific vehicle driver. Accordingly, the augmented reality image 21-1 may provide a path to the destination 40 within the building of the specific vehicle driver.

According to another embodiment of the present invention, as illustrated in FIG. 8, a plurality of electronic devices 10-1 and 10-2 constituting a plurality of sensor device infrastructures may be positioned in a parking lot, and communication may also be established between the electronic devices 10-1 and 10-2 constituting the plurality of sensor device infrastructures. Communication may also be established between an external terminal 100 and the electronic devices 10-1 and 10-2 constituting the plurality of sensor device infrastructures, communication may also be established between an AR device 20 and the electronic devices 10-1 and 10-2 constituting the plurality of sensor device infrastructures, and communication may also be established between the AR device 20 and the external terminal 100. In this case, through communication between the external terminal 100 and the electronic devices 10-1 and 10-2 constituting the plurality of sensor device infrastructures, it is possible to determine an optimal parking space by communicating with the AR device 20 in real time in consideration of vacant spaces in the parking lot, preferred parking spaces of drivers, and final destinations of drivers. Alternatively, the optimal parking spots may be highlighted and provided as an augmented reality image 21-1 along with the location of the vehicle 30 of the driver wearing the AR device in the current parking lot. In addition, the AR device processor unit 23 may determine the optimal parking spot through communication with the electronic devices 10-1 and 10-2 constituting the plurality of sensor device infrastructures without going through communication between the external terminal 100 and the electronic devices 10-1 and 10-2 constituting the plurality sensor device infrastructures.

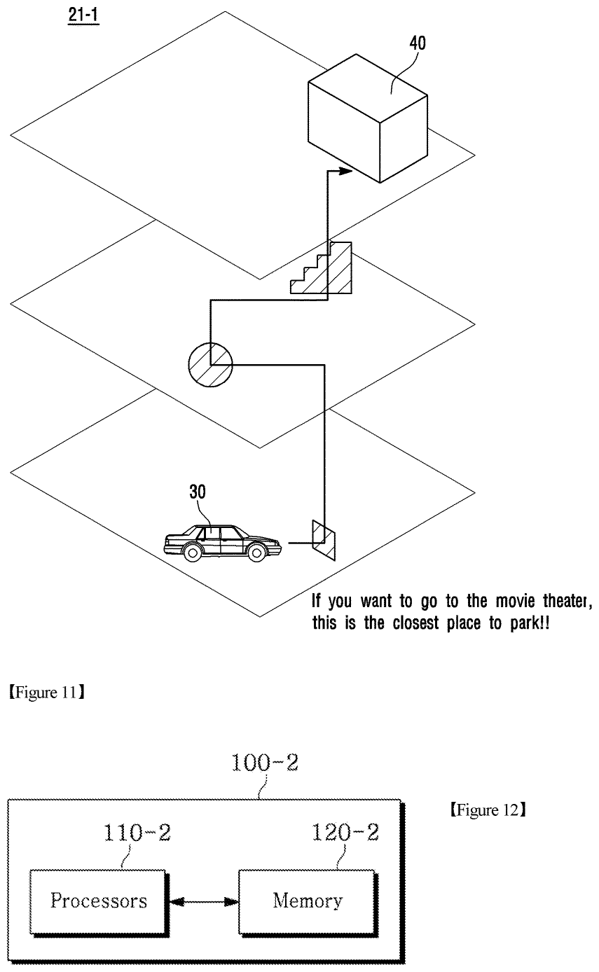

FIG. 11 is a schematic view illustrating a traffic accident analysis system according to an embodiment of the present invention.

As illustrated in FIG. 11, the traffic accident analysis system 1100 includes a camera 1112, a video surveillance device 1114, a management server 1120, a database (DB 1130, and a user terminal 1140.

The camera 1112 is installed on the smart pole 1110 and captures various traffic images occurring on the road. The camera 1112 is, for example, a device capable of capturing still images and moving images, and according to an embodiment, may include one or more image sensors, a lens, an image signal processor (ISP), or a flash (e.g., an LED or xenon lamp, etc.). The camera 1112 may generate a road traffic image signal corresponding to an input external image and output the generated road traffic image signal to the image surveillance device 1114. The image of the camera 1112 used in the present invention is a road traffic image captured from above by being installed on the smart pole 1110, and may obtain information on a wider space than the black box image of the vehicle.

A video surveillance device 1114 may also be installed on a smart pole 1110 and may monitor traffic accidents occurring on the road, including vehicle accidents, pedestrian occurrences, or a combination thereof, from road traffic images captured by a camera 1112. The video surveillance device 1114 may calculate the distance and angle from the camera 1112 image to the vehicle through planar processing of the image in the event of a traffic accident, thereby generating a planar traffic accident image and providing the image to the management server 1120. Meanwhile, the video surveillance device 1114 may compare the planar traffic accident image with a standard traffic accident image to determine how similar the planar traffic accident image is to at least one of the standard traffic accident images.

The management server 1120 may manage traffic accident-related videos together with road traffic videos received from each video surveillance device 1114 installed in a plurality of smart poles 1110. The management server 1120 may store traffic accident-related videos together with the received road traffic videos in a database 1130.

A plurality of standard traffic accident images may be stored in the database 1130. Accordingly, a plurality of standard traffic accident information and a plurality of actual traffic accident images may be stored in the database 1130. Here, the standard traffic accident information may include traffic accident data provided by the Road Traffic Authority, etc., and may include the negligence ratio established by court precedents, etc.

The user terminal 1140 is an electronic device for displaying the similarity of an actual traffic accident video, for example, the type of accident and the cause of the accident. The user terminal 1140 receives and displays an actual traffic accident video and a standard traffic accident video similar to the actual traffic accident video from a video surveillance device 1114 or a management server 1120, and may also display the similarity and the fault ratio. Here, the user terminal 1140 may be an electronic device of the Non-life Insurance Association or an electronic device of an accident party.

In FIG. 11, it is described that the traffic accident similarity is estimated by the video surveillance device 1114, but the traffic accident similarity estimation may also be processed by the management server 1120. Therefore, the traffic accident analysis system may be the video surveillance device 1114 or the management server 1120. Meanwhile, in FIG. 11, the management server 1120 and the database 1130 are depicted separately, but the function of the database may be implemented in the management server 1120.

FIG. 12 is a block diagram illustrating a case in which the video surveillance device or management server illustrated in FIG. 11 operates as a general electronic device.

As illustrated in FIG. 12, an electronic device 1200 connected to a network is described. The electronic device 1200 may include a bus 1210, a processor 1220, a memory 1230, an input/output interface 1250, a display 1260, and a communication interface 1270. In some embodiments, the electronic device 1200 may omit at least one of the components or may additionally include other components. The bus 1210 may include a circuit that connects the components 1220-1270 to each other and transmits communication (e.g., control messages or data) between the components. The processor 1220 may include one or more of a central processing unit, an application processor, or a communication processor (CP). The processor 1220 may execute, for example, calculations or data processing related to control and/or communication of at least one other component of the electronic device 1200.

The memory 1230 may include volatile and/or nonvolatile memory. The memory 1230 may store, for example, instructions or data related to at least one other component of the electronic device 1200. According to an embodiment, the memory 1230 may store software and/or programs 1240. The programs 1240 may include, for example, a kernel 1241, middleware 1243, an application programming interface (API) 1245, and/or an application program (or “application”) 1247. At least a portion of the kernel 1241, the middleware 1243, or the API 1245 may be referred to as an operating system. The kernel 1241 may control or manage system resources (e.g., a bus 1210, a processor 1220, or a memory 1230) used to execute operations or functions implemented in other programs (e.g., a middleware 1243, an API 1245, or an application program 1247). In addition, the kernel 1241 may provide an interface that allows the middleware 1243, the API 1245, or the application program 1247 to control or manage system resources by accessing individual components of the electronic device 1200.

The middleware 1243 may act as an intermediary so that, for example, the API 1245 or the application program 1247 may communicate with the kernel 1241 to exchange data. In addition, the middleware 1243 may process one or more task requests received from the application program 1247 according to priorities. For example, the middleware 1243 may give priority to at least one of the application programs 1247 to use the system resources (e.g., the bus) 1210, the processor 1220, or the memory 1230) of the electronic device 1200 and process the one or more task requests. The API 1245 may be an interface for the application 247 to control functions provided by the kernel 1241 or the middleware 1243, and may include, for example, at least one interface or function (e.g., a command) for file control, window control, image processing, or character control. The input/output interface 1250 may, for example, transmit commands or data input from a user or another external device to other component(s) of the electronic device 1200, or output commands or data received from other component(s) of the electronic device 1200 to the user or another external device.

The display 1260 may include, for example, a liquid crystal display (LCD), a light emitting diode (LED) display, an organic light emitting diode (OLED) display, a micro electro mechanical systems (MEMS) display, or an electronic paper display. The display 1260 may display, for example, various contents (e.g., text, images, videos, icons, and/or symbols) to a user. The display 1260 may include a touch screen and may receive touch, gesture, proximity, or hovering inputs, for example, using an electronic pen or a part of the user's body.

The communication interface 1270 may establish communication with, for example, another electronic device (not shown). For example, the communication interface 1270 may be connected to a network via wireless communication or wired communication to communicate with the other electronic device. Here, the wireless communication may include, for example, cellular communication using at least one of LTE, LTE-A (LTE Advance), CDMA (code division multiple access), WCDMA (wideband CDMA), UMTS (universal mobile telecommunications system), WiBro (Wireless Broadband), or GSM (Global System for Mobile Communications). According to an embodiment, the wireless communication may include, for example, at least one of WiFi (wireless fidelity), Bluetooth, Bluetooth low energy (BLE), Zigbee, near field communication (NFC), Magnetic Secure Transmission, Radio Frequency (RF), or Body Area Network (BAN). According to an embodiment, the wireless communication may include GNSS. GNSS may be, for example, GPS (Global Positioning System), Glonass (Global Navigation Satellite System), Beidou Navigation Satellite System (hereinafter “Beidou”), or Galileo, the European global satellite-based navigation system. Hereinafter, in this document, “GPS” may be used interchangeably with “GNSS”. The wired communication may include, for example, at least one of USB (universal serial bus), HDMI (high definition multimedia interface), RS-232 (recommended standard232), power line communication, or POTS (plain old telephone service). The network 1262 may include at least one of a telecommunications network, for example, a computer network (e.g., LAN or WAN), the Internet, or a telephone network.

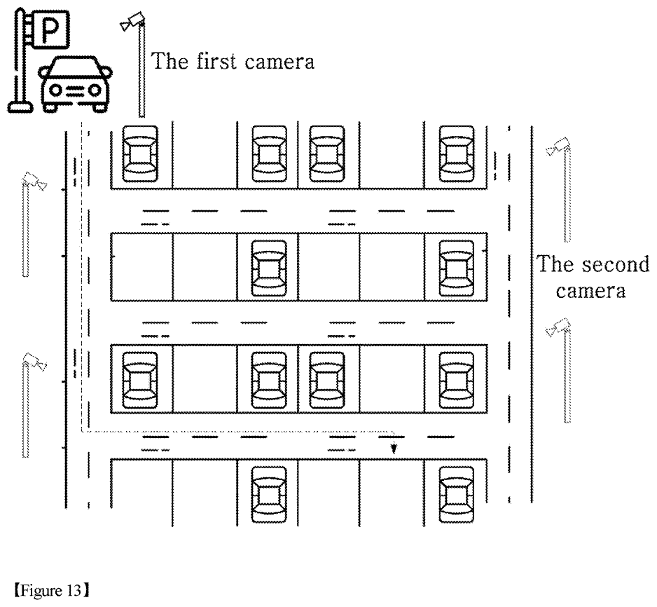

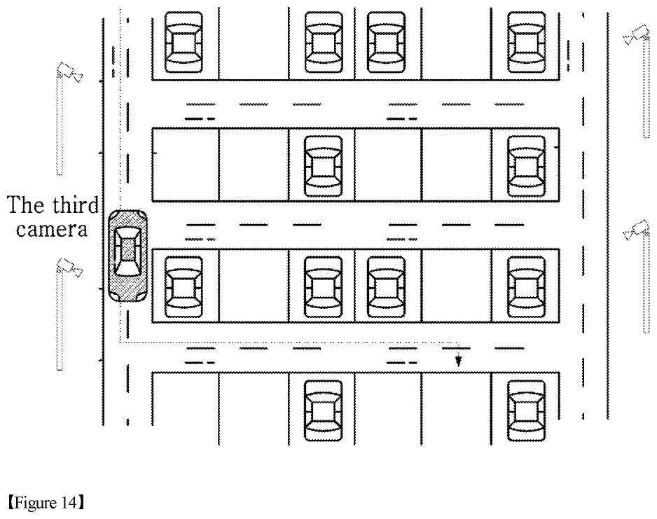

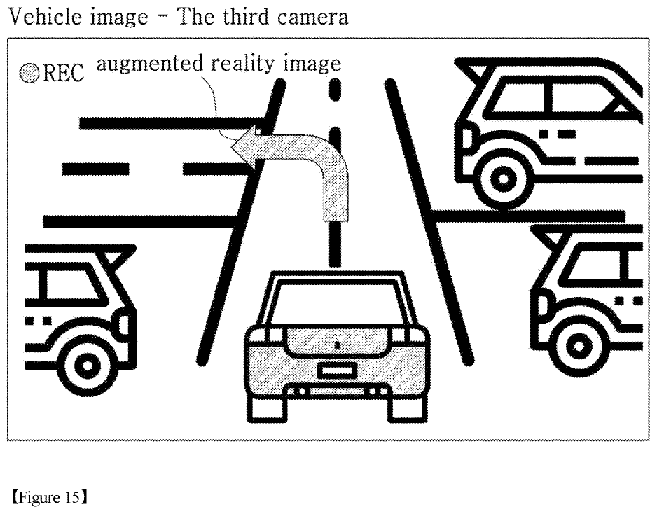

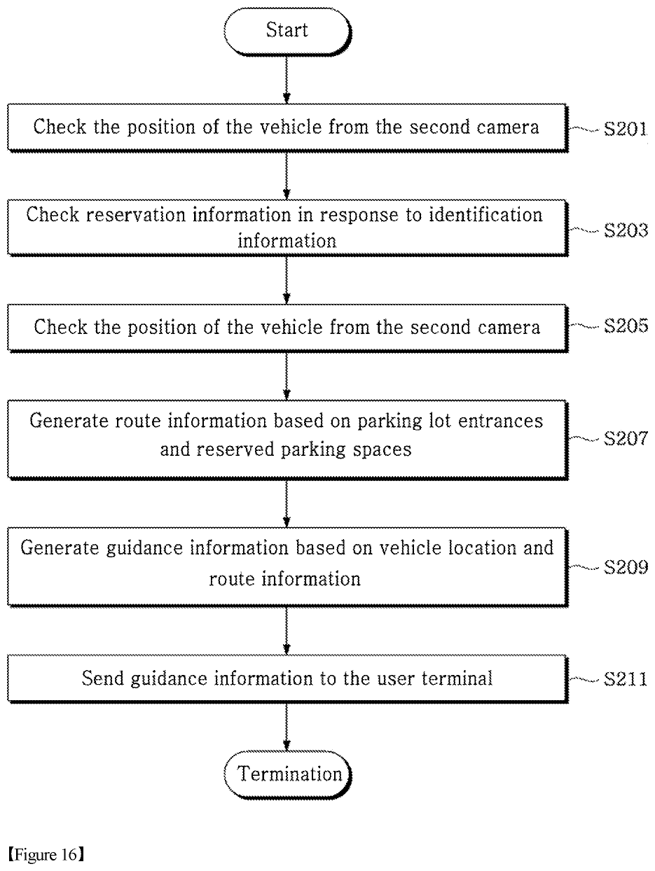

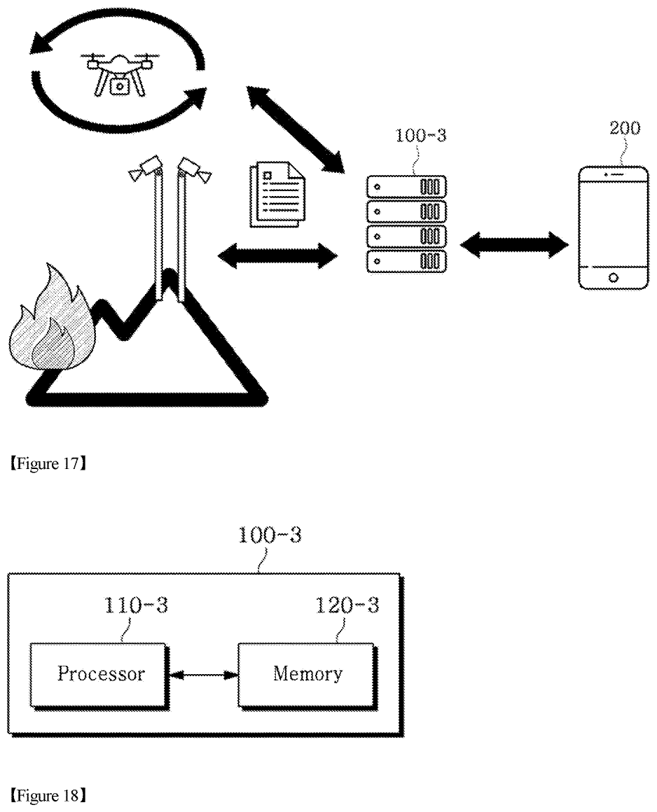

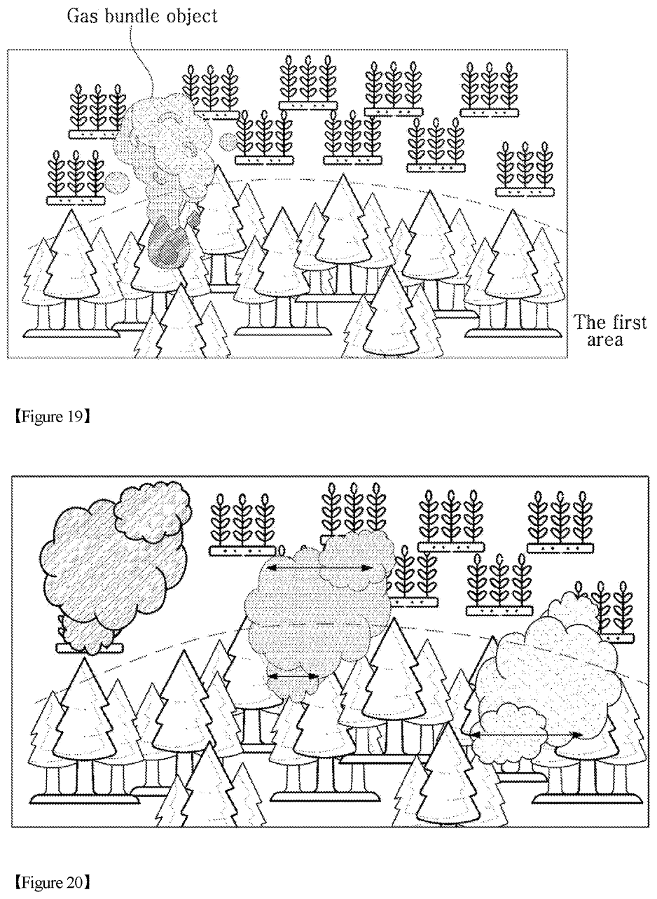

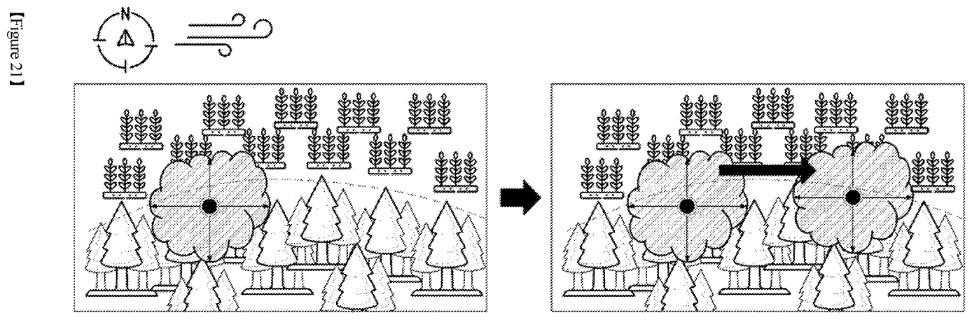

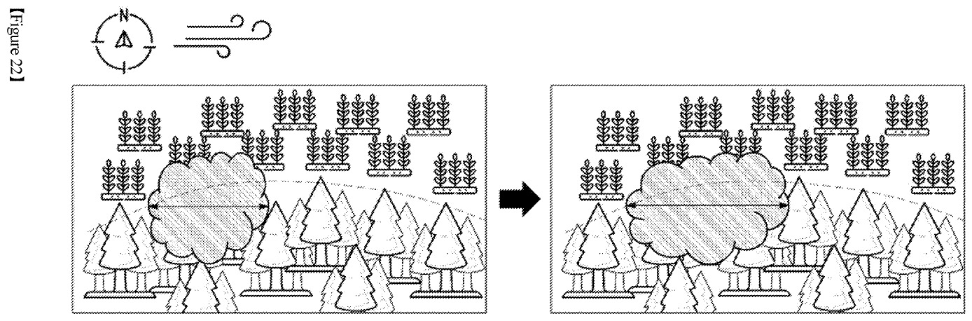

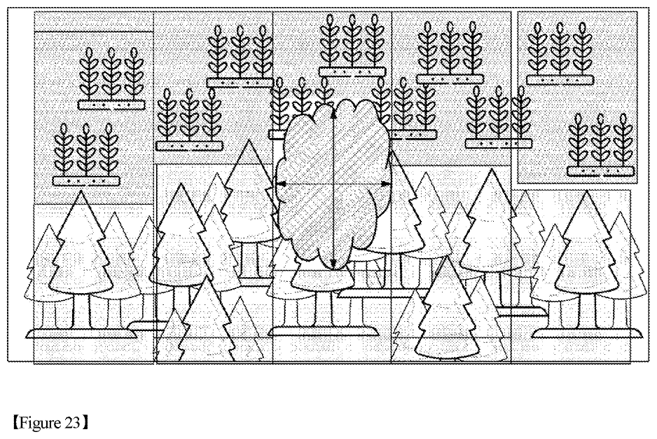

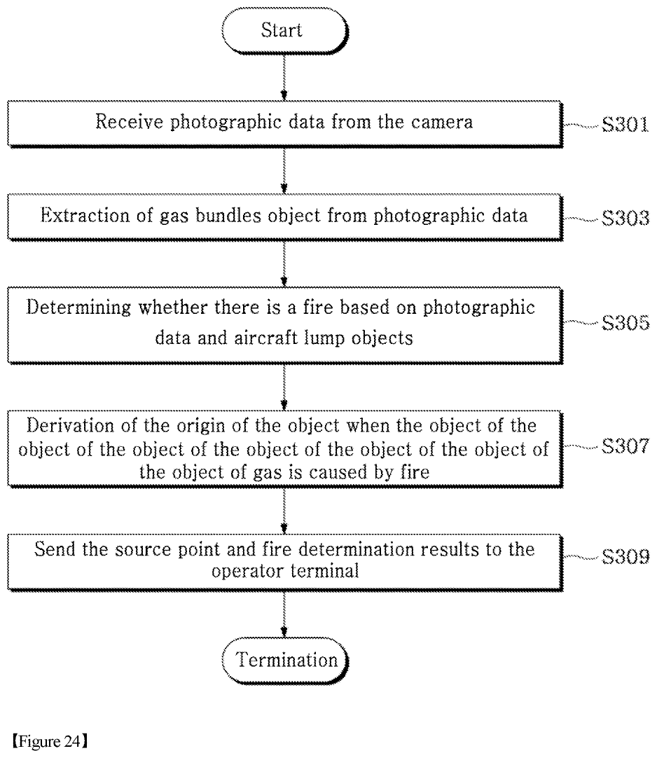

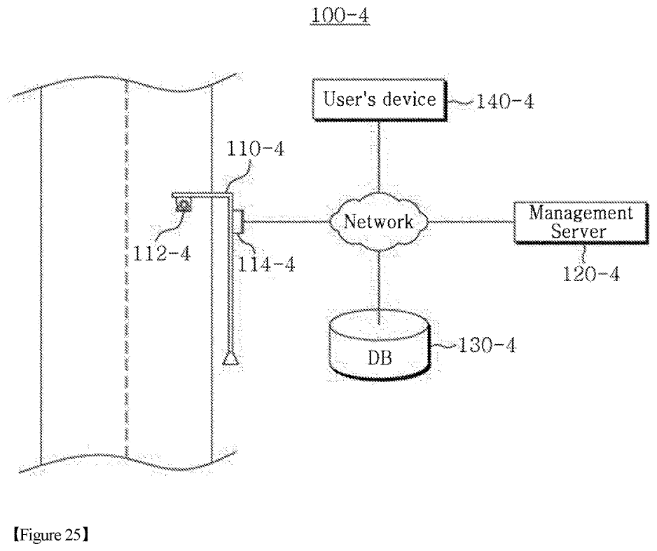

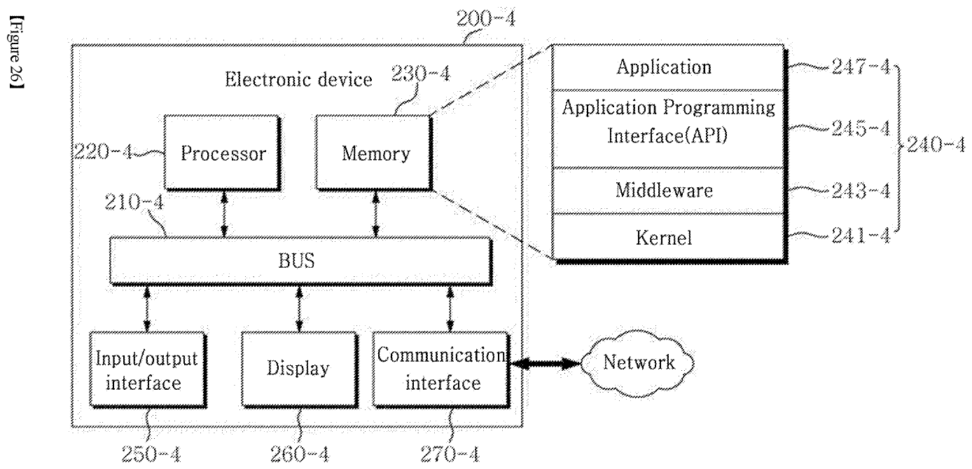

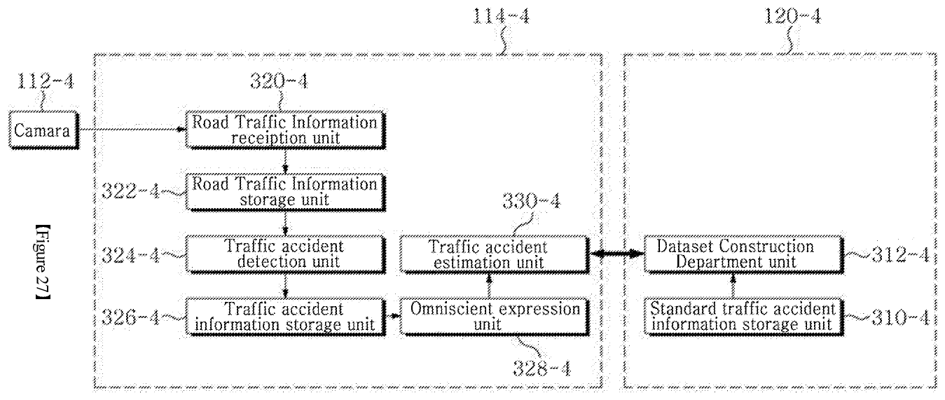

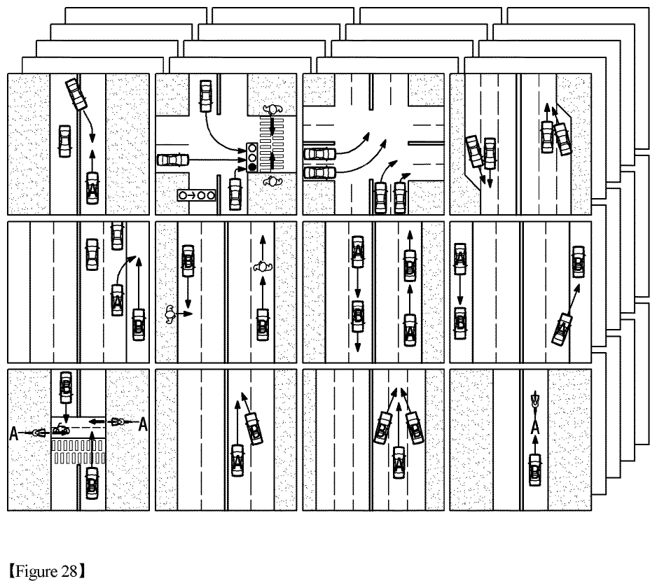

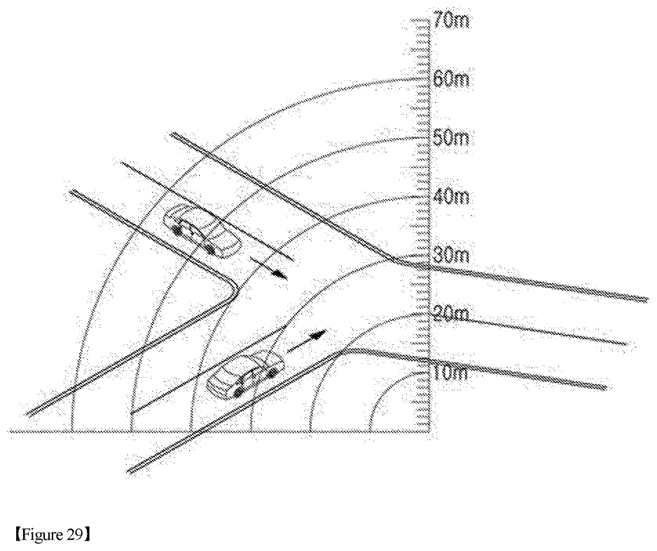

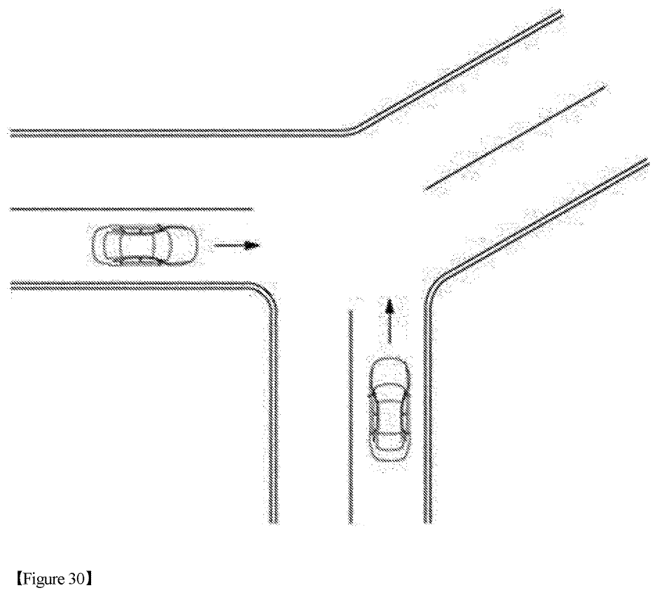

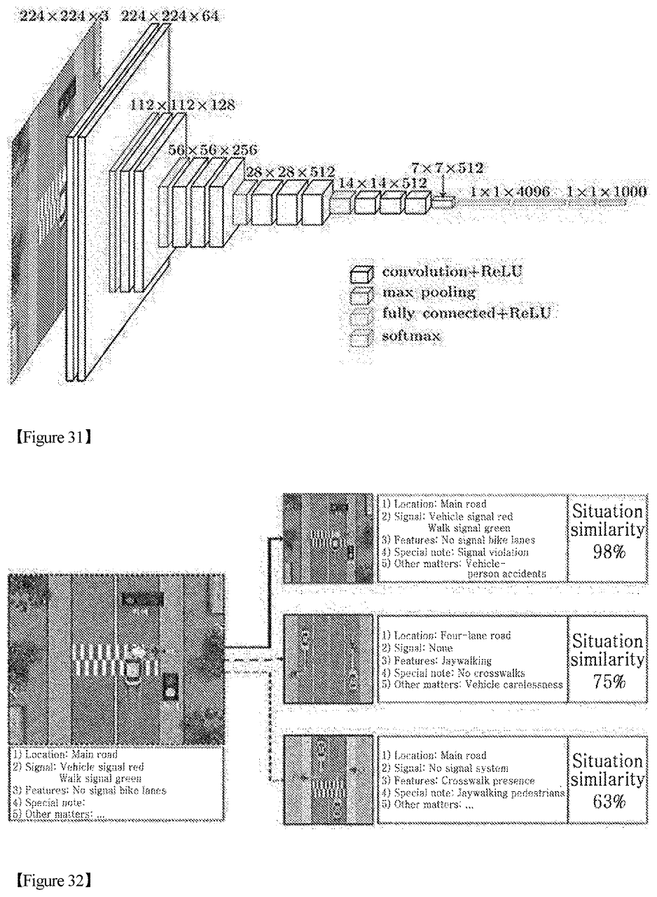

FIG. 13 is a block diagram of a traffic accident analysis system according to an embodiment of the present invention. FIG. 14 is a view illustrating examples of two-dimensional images by type and/or situation of a standard traffic accident according to an embodiment of the present invention. FIG. 15 and FIG. 16 are views illustrating examples of matching camera images to a map as illustrated according to an embodiment of the present invention. FIG. 17 is a view illustrating an example of estimating a standard traffic accident type of an actual traffic accident situation according to an embodiment of the present invention. FIG. 18 is a view illustrating an example of displaying a standard traffic accident estimation result of an actual traffic accident situation according to an embodiment of the present invention.

As illustrated in FIG. 13, the traffic accident analysis system 1100 may include a camera 1112, a video surveillance device 1114, and a management server 1120.

The management server 1120 may include a standard traffic accident information storage unit 1310 and a dataset construction unit 1312. The standard traffic accident information storage unit 1310 stores a plurality of standard traffic accident information that are generally used. Here, standard traffic accident information may include traffic accident data provided by the Road Traffic Authority, etc., and may include negligence ratios established by court precedents, etc. Examples of two-dimensional images of types and/or situations of standard traffic accidents according to embodiments of the present invention are illustrated in FIG. 14.

The dataset construction unit 1312 constructs a dataset to be used in the traffic accident estimation unit 1330. For this, the dataset construction unit 1312 may first classify traffic accident types that may occur on the road, such as vehicle-to-vehicle (vehicle to vehicle), vehicle-to-person (vehicle to pedestrian), vehicle-to-two-wheeler (vehicle to two-wheeler), and vehicle-to-bicycle (vehicle to bicycle), using images of standard traffic accident information. The dataset construction unit 1312 may perform labeling on traffic accident images using images in which traffic accident types are classified. Here, labeling may be passenger cars, trucks, buses, and ambulances when vehicles are the standard, and adults, elderly people, and children when people are the standard. In addition, the dataset construction unit 1312 may further use text data, which is explanatory material explaining traffic accidents, in addition to traffic accident images. In this case, the dataset may include images and text. Meanwhile, the dataset construction unit 1312 may construct a dataset by introducing artificial intelligence modeling and comparing and evaluating a large number of actual traffic accident data.

The video surveillance device 1114 may include a road traffic information receiving unit 1320, a road traffic information storage unit 1322, a traffic accident identification unit 1324, a traffic accident information storage unit 1326, an omniscient expression unit 1328, and a traffic accident estimation unit 1330.

The road traffic information receiving unit 1320 receives real-time road traffic images provided from the camera 1112.

The road traffic information storage unit 1322 stores the road traffic images received from the road traffic information receiving unit 1320. The images stored in the road traffic information storage unit 1322 may be stored as new files at predetermined time intervals, for example, every 2 minutes. That is, a 2-minute image may be stored as a first file, the next 2-minute image may be stored as a second file, and the 2-minute image may be stored again as a third file. In addition, only the files of the previous 2 images may be maintained and the remaining files may be deleted. Accordingly, the files stored in the road traffic information storage unit 1322 may store the previous 2 files and 1 file being recorded.

The traffic accident identification unit 1324 identifies whether there is a traffic accident among the road traffic images being recorded. When a traffic accident is identified in the traffic accident identification unit 1324, the traffic accident identification unit 1324 may copy and store the traffic accident information stored in the road traffic information storage unit 1322 when the traffic accident occurs in the traffic accident information storage unit 1326. The traffic accident information stored in the traffic accident information storage unit 1326 may be provided to the management server 1120.

The omniscient expression unit 1328 converts traffic accident images from the identification of the accident vehicle to the occurrence of the accident, for example, in units of 1 to 5 seconds, into omniscient expressions among the actual traffic accident information stored in the traffic accident information storage unit 1326.

The omniscient expression unit 1328 may first display circular distance lines at predetermined distance intervals, for example, 1 to 10 meter intervals, on the traffic accident image for omniscient expression of the image. Here, the circular distance lines may be values obtained in advance through images obtained while installing a camera 1112 on a smart pole 1110. The omniscient expression unit 1328 may then display bounding boxes using the boundaries of the identified objects. Here, the bounding box for the vehicle may be used to calculate the direction and angle of travel of the vehicle. The omniscient expression unit 1328 may then perform a task of matching a two-dimensional map with the actual location of the scene. Here, the two-dimensional flat map may be a map as illustrated. Accordingly, the location of the vehicle in the traffic accident image may be mapped onto the two-dimensional flat map by considering the distance and angle from the smart pole 1110. The omniscient expression unit 1328 may display an accident image as an omniscient expression on a two-dimensional flat map for a predetermined time period, for example, 1 to 5 seconds, from the identification of the accident vehicle until the accident occurs. An example of a camera image according to an embodiment of the present invention is illustrated in FIG. 15, and an example matching the map as illustrated is illustrated in FIG. 16.

The traffic accident estimation unit 1330 may estimate similar standard traffic accident information by learning actual traffic accident information using the standard traffic accident data set constructed in this way. On the one hand, the traffic accident estimation unit 1330 may estimate similar standard traffic accidents and their similarity to the corresponding traffic accident by learning about the actual traffic accident data set constructed from actual traffic accident information. In this case, the traffic accident estimation unit 1330 may analyze the image by applying a convolutional neural network (CNN). The CNN consists of a part that extracts features of the image in a way that effectively recognizes and emphasizes features from adjacent images while maintaining the spatial information of the image, and a part that classifies the image. The feature extraction area may include a convolutional layer that finds features of the image while minimizing the number of shared parameters using a filter, and a pooling layer that strengthens and collects features. An example of estimating a standard traffic accident type of an actual traffic accident situation according to an embodiment of the present invention is illustrated in FIG. 17.

Therefore, the traffic accident estimation unit 1330 may estimate how similar the two-dimensional planar traffic accident image expressed in the omniscient expression unit 1328 is to at least one of the standard traffic accident images by comparing the planar traffic accident image with the standard traffic accident image. An example of a standard traffic accident estimation result of an actual traffic accident situation according to an embodiment of the present invention is illustrated in FIG. 18.

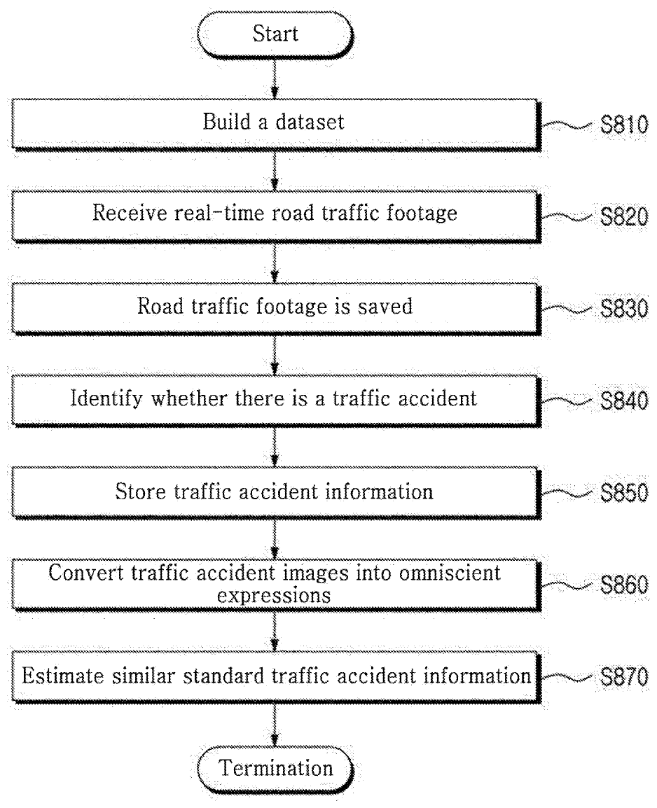

FIG. 19 is a flow chart representing a traffic accident analysis method according to another embodiment of the present invention.

The dataset construction unit 1312 of the management server 1120 constructs a dataset to be used in the traffic accident estimation unit 1330 from a plurality of standard traffic accident information stored in the standard traffic accident information storage unit 1310 in operation S810. To this end, the dataset construction unit 1312 may first classify traffic accident types that may occur on the road, such as vehicle-to-vehicle (vehicle to vehicle), vehicle-to-person (vehicle to pedestrian), vehicle-to-two-wheeler (vehicle to two-wheeler), and vehicle-to-bicycle (vehicle to bicycle), using images of standard traffic accident information. The dataset construction unit 1312 may perform labeling on traffic accident images using images in which traffic accident types are classified. Here, labeling may be passenger cars, trucks, buses, and ambulances when vehicles are the standard, and adults, elderly people, and children when people are the standard. In addition, the dataset construction unit 1312 may further use text data, which is explanatory material explaining traffic accidents, in addition to traffic accident images. In this case, the dataset may contain images and text.

The road traffic information receiving unit 1320 of the video surveillance device 1114 receives real-time road traffic images provided from the camera 1112 in operation S820. The road traffic information storage unit 1322 stores the road traffic images received from the road traffic information receiving unit 1320 in operation S830. Images stored in the road traffic information storage unit 1322 may be stored as new files every two minutes, for example.

The traffic accident identification unit 1324 identifies whether there is a traffic accident among the road traffic images being recorded in operation S840. If a traffic accident is identified in the traffic accident identification unit 1324, the traffic accident identification unit 1324 copies and stores the traffic accident information stored in the road traffic information storage unit 1322 when the traffic accident occurs in the traffic accident information storage unit 1326 in operation S850. The traffic accident information stored in the traffic accident information storage unit 1326 may be provided to the management server 1120.

The omniscient expression unit 1328 converts a traffic accident image into an omniscient expression from among the actual traffic accident information stored in the traffic accident information storage unit 1326 for a predetermined time, for example, 1 to 5 seconds, from the identification of the accident vehicle to the occurrence of the accident in operation S860. For the omniscient expression of the image, the omniscient expression unit 1328 may first display a circular distance line at a predetermined distance interval, for example, 1 to 10 meters, on the traffic accident image. Here, the circular distance line may be a value obtained in advance through an image obtained while installing a camera 1112 on a smart pole 1110. The omniscient expression unit 1328 may then display a bounding box using the boundaries of the identified objects. Here, the bounding box for the vehicle may be used to calculate the direction and angle of travel of the vehicle. The omniscient expression unit 1328 may then perform a task of matching a two-dimensional map with the location of the actual scene. Here, the two-dimensional flat map may be a map as illustrated. In this way, the vehicle location in the traffic accident video may be mapped onto a two-dimensional flat map by considering the distance and angle from the smart pole 1110. The omniscient expression unit 1328 may display the accident video as an omniscient expression on the two-dimensional flat map for a predetermined time period, for example, 1 to 5 seconds, from the identification of the accident vehicle until the accident occurs.

The traffic accident estimation unit 1330 estimates similar standard traffic accident information by learning actual traffic accident information using the standard traffic accident data set constructed in this manner in operation S870. On the one hand, the traffic accident estimation unit 1330 may estimate similar standard traffic accidents and their similarity to the corresponding traffic accident by learning about the actual traffic accident data set constructed from actual traffic accident information. In this case, the traffic accident estimation unit 1330 may analyze the image by applying a convolutional neural network (CNN). The CNN consists of a part that extracts image features in a way that effectively recognizes and emphasizes features from adjacent images while maintaining the spatial information of the image, and a part that classifies the image. The feature extraction area may include a convolutional layer that finds features of the image while minimizing the number of shared parameters using a filter, and a pooling layer that strengthens and collects features.

The embodiments described above may be implemented as hardware components, software components, and/or a combination of hardware components and software components. For example, the devices, methods, and components described in the embodiments may be implemented using one or more general-purpose computers or special-purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing instructions and responding to the instructions. The processing device may execute an operating system (OS) and one or more software applications running on the OS. In addition, the processing device may access, store, manipulate, process, and generate data in response to the execution of the software. For ease of understanding, the processing device is sometimes described as being used alone, but those skilled in the art will appreciate that the processing device may include a plurality of processing elements and/or a plurality of types of processing elements. For example, the processing device may include a plurality of processors, or a processor and a controller. Other processing configurations, such as parallel processors, are also possible.

The method according to the embodiment may be implemented in the form of program commands that may be executed through various computer means and recorded on a computer-readable medium. The computer-readable medium may include program commands, data files, data structures, etc., alone or in combination. The program commands recorded on the medium may be those specially designed and configured for the embodiment or may be those known to and available to those skilled in the art of computer software. Examples of the computer-readable recording medium include magnetic media such as hard disks, floppy disks, and magnetic tapes, optical media such as CDROMs and DVDs, magneto-optical media such as floptical disks, and hardware devices specially configured to store and execute program commands such as ROMs, RAMs, and flash memories. Examples of program instructions include machine language code, such as that produced by a compiler, as well as high-level language code that may be executed by a computer using an interpreter, etc. The hardware devices may be configured to operate as one or more software modules to perform the operations of the embodiments, and vice versa.

Software may include a computer program, code, instructions, or a combination of one or more of these, which may configure a processing device to perform a desired operation or may independently or collectively command the processing device. Software and/or data may be interpreted by a processing device or may be connected to any type of machine, component, physical device, virtual

The software may be permanently or temporarily embodied in a virtual equipment, a computer storage medium or device, or a transmitted signal wave. The software may also be distributed over network-connected computer systems and stored or executed in a distributed manner. The software and data may be stored on one or more computer-readable recording media.

Although the embodiments have been described with limited drawings as described above, those skilled in the art may apply various technical modifications and variations based on the above. For example, even if the described techniques are performed in a different order than the described method, and/or the components of the described system, structure, device, circuit, etc. are combined or combined in a different form than the described method, or are replaced or substituted by other components or equivalents, appropriate results may be achieved.

Therefore, other implementations, other embodiments, and equivalents to the claims are also included in the scope of the claims described below.

1. A system for notifying a road occurred event by using a sensor device, the system comprising:
an electronic device that configures a sensor device infrastructure that communicates with each other according to a communication protocol; and
a user terminal,
wherein the electronic device that configures the sensor device infrastructure comprises:
a sensor device that captures an image of a road;
a processor that directly processes an image processing-based artificial intelligence model and determines a road occurred event by using the image of the road, captured by the sensor device, as an input of the image processing-based artificial intelligence model ; and
a memory,
wherein the user terminal comprises:
a user terminal processor unit that receives data related to the determined the road occurred event according to the communication protocol; and
an output unit that outputs the received data.

2. The system of claim 1, wherein the user terminal processor unit directly processes the image processing-based artificial intelligence model, receives the image of the road captured by the sensor device, and determines a portion or all of the road occurred event by using the image of the road as the input of the image processing-based artificial intelligence model.

3. The system of claim 2, wherein the road occurred event is at least one of a traffic accident on the road, a traffic jam on the road, construction on the road, a breakdown of a facility on the road, a regulation on the road, illegal parking on the road, and an occurrence of a vehicle violating traffic rules on the road.

4. The system of claim 2, wherein the output unit outputs an augmented reality image related to the road occurred event.

5. The system of claim 2,
wherein the processor classifies the road occurred event based on a classification model learned using actual road occurred events as label data.

6. A system for notifying a road occurred event by using a sensor device, the system comprising:
an electronic device that configures a sensor device infrastructure that communicates with each other according to a communication protocol;
a user terminal; and
an external terminal,
wherein the electronic devices that configures the sensor device infrastructure comprise:
a sensor device that captures an image of a road;
a processor that directly processes an image processing-based artificial intelligence model and determines the road occurred event by using the image of the road, captured by the sensor device, as an input of the image processing-based artificial intelligence model; and
a memory,
wherein the external terminal comprises an external terminal processor that processes a general-purpose artificial intelligence model and receives at least one of an image of the road captured by the sensor device and data regarding the road occurred event determined by the processor, and determines a portion or all of the road occurred event by using at least one of the received image of the road captured by the sensor device and data regarding an the received road occurred event determined by the processor as an input of the general-purpose artificial intelligence model,
wherein the user terminal comprises:
a user terminal processor unit that receives at least one of data regarding the road occurred event determined by the processor through the communication protocol and data regarding the road occurred event determined by the external terminal processor; and
an output unit that outputs the received data.

7. The system of claim 6, wherein the user terminal processor unit directly processes the image processing-based artificial intelligence model, receives the image of the road captured by the sensor device, and determines a portion or all of the road occurred event by using the image of the road as the input of the image processing-based artificial intelligence model.

8. The system of claim 7, wherein the road occurred event is at least one of a traffic accident on the road, a traffic jam on the road, construction on the road, a breakdown of a facility on the road, a regulation on the road, illegal parking on the road, and an occurrence of a vehicle violating traffic rules on the road.

9. The system of claim 7, wherein the output unit outputs an augmented reality image related to the road occurred event.

10. The system of claim 7, wherein the processor classifies the road occurred event based on a classification model learned using actual road occurred events as label data.
